(19) United States
(12) Patent Application Publication
(10) Pub. No.: US 2022/0081542 A1
(43) Pub. Date: Mar. 17, 2022

(54) COMPOSITIONS AND METHODS FOR USE IN THE PREPARATION OF HYDROPHOBIC SURFACES

(71) Applicant: Kafrit Industries (1993) Ltd., Kibbutz Kfar Aza (IL)

(72) Inventors: Roee Levi, Be'er Tuvia (IL); Hanna Schwartz, Meitar (IL); Nadav Goldstein, Kibbutz Kfar Aza (IL); Amos Ophir, Zikhron Ya'akov (IL)

(21) Appl. No.: 17/534,917

(22) Filed: Nov. 24, 2021

Related U.S. Application Data
(63) Continuation-in-part of application No. PCT/IL2020/050588, filed on May 27, 2020.

(30) Foreign Application Priority Data
May 28, 2019 (GB) 1907511.8

(51) Int. Cl. C08L 23/06; C08J 3/22; C08J 5/18; C08J 9/08; C08J 9/10

(52) U.S. Cl. CPC C08L 23/06; C08J 2427/22; C08J 5/18; C08J 9/08; C08J 9/103; C08L 2310/00; C08L 2203/16; C08L 2203/14; C08L 2207/066; C08L 2205/025; C08L 2205/03; C08L 2205/24; C08J 2203/02; C08J 2203/04; C08J 2323/06; C08J 2423/06; C08J 3/226

(57) ABSTRACT

Polymer films having a surface with increased hydrophobicity or enhanced hydrophobicity or improved hydrophobicity or super-hydrophobicity; composite structures such as multilayer polymer sheets comprising the polymer films; methods and systems of making such polymer films; polymer blends from which to make such polymer films; masterbatches or masterbatch compositions useful for making such polymer blends; as well as methods and systems for making such polymer blends and such masterbatches or masterbatch compositions.

### CROSS-REFERENCE TO RELATED APPLICATION

This patent application is a Continuation-In-Part (CIP) of PCT international application number PCT/IL2020/050588, having an international filing date of May 27, 2020, published as international publication number WO 2020/240557 A1, which is hereby incorporated by reference in its entirety; which claims priority from United Kingdom patent application number GB 1907511.8, filed on May 28, 2019, which is hereby incorporated by reference in its entirety.

### FIELD AND BACKGROUND OF THE INVENTION

The invention, in some embodiments, belongs to the technical field of new materials, in particular to compositions for use in the preparation of hydrophobic surfaces, methods of use thereof and hydrophobic surfaces produced using such compositions and methods.

Wettability is an important property of a solid surface. The wettability of a solid surface by water is often quantified in terms of contact angle, which is defined as the angle formed at the water-solid interface when a water drop is deposited on the solid surface. A solid surface having a static contact angle with water of less than 90° is considered hydrophilic and greater than 90° is considered to be hydrophobic. For many uses, a surface having higher hydrophobicity is preferred.

Background art includes the following patents and/or published patent applications, and each one of them is hereby incorporated by reference in its entirety: U.S. Pat. Nos. 4,952,352; 9,040,145; 7,491,762; 8,563,621; US 2005/0064120; US 2015/0025619; WO 2016/082212; CN 108299586; CN 107384191; CN 107652821; CN 1037159.

There is a need for processes and materials useful for providing surfaces having increased hydrophobicity for example, of plastic articles or other products.

### SUMMARY OF THE INVENTION

According to an aspect of some embodiments of the present invention there is provided masterbatch composition suitable for use in preparing a polymer film having a surface with increased hydrophobicity, the masterbatch composition comprising:
a foamable polyolefin component comprising at least one foamable polyolefin;
a fluoropolymer component comprising at least one fluoropolymer; and
a blowing agent component comprising at least one heat-activated blowing agent which is non-gaseous prior to activation by the application of heat,
   wherein fluoropolymer component is homogeneously dispersed in at least some the foamable polyolefin component, and
   wherein the masterbatch has a form suitable for use as extruder feed.

According to some embodiments, the masterbatch is in the form of a plurality of particles suitable for feeding to an extruder.

According to some embodiments, said polyolefin component makes up between 15% and 86% weight percent of the masterbatch composition.

According to some embodiments, said fluoropolymer component makes up between 10% and 15% weight percent of the masterbatch composition.

According to some embodiments, said blowing agent component makes up between 4% and 70% weight percent of the masterbatch composition.

According to some embodiments, said foamable polyolefin component, said fluoropolymer component and said blowing agent component together comprise not less than 90% by weight of the masterbatch composition.

According to some embodiments, said polyolefin component is at least 90% by weight of a foamable polyolefin selected from the group consisting of polyethylene (PE), polypropylene (PP) and combinations thereof.

According to some embodiments, at least one fluoropolymer making up said fluoropolymer component is selected from the group consisting of a fluoro homopolymer, a fluoro copolymer, a fluoroelastomer, an acrylic-modified fluoropolymer or a combination thereof.

According to some embodiments, said fluoropolymer component is at least 50% by weight of acrylic-modified fluoropolymer.

According to some embodiments, said blowing agent component comprises a an azodicarbonamide blowing agent.

According to some embodiments, the masterbatch composition further comprises a nucleator component.

According to some embodiments, said nucleator component makes up between 0.1% and 10% weight percent of the masterbatch composition.

According to some embodiments, said foamable polyolefin component, said fluoropolymer component, said blowing agent component and said nucleator component together comprise not less than 90% by weight of the masterbatch composition.

According to some embodiments, the masterbatch comprises:

a polyolefin component comprising foamable polyethylene;

homogeneously dispersed in at least some of said polyolefin component, a fluoropolymer

component comprising an acrylic-modified fluoropolymer; and

homogeneously dispersed in at least some of the polyolefin component, a blowing agent

component comprising an azodicarbonamide blowing agent.

According to an aspect of some embodiments of the present invention, there is provided a polymer blend composition, comprising:

between 1% and 30% by weight of the masterbatch as disclosed herein, and

between 70% and 99% by weight of a bulk foamable polyolefin.

According to some embodiments, said masterbatch and said bulk foamable polyolefin together make up not less than 90% by weight of the polymer blend.

According to some embodiments, the polymer blend composition comprises between not less than 0.1% and not more than 10% fluoropolymer by weight.

According to some embodiments, the polymer blend composition comprises not less than 80% by weight polyolefin.

According to some embodiments, the polymer blend composition comprises not more than 10% by weight inorganic particles.

According to some embodiments, said bulk foamable polyolefin comprises at least 90% by weight of a foamable polyolefin selected from the group consisting of PE, PP, polyvinyl chloride and combinations thereof.

According to some embodiments, the polymer blend composition comprises:

as a bulk foamable polyolefin, polyethylene; and

a masterbatch composition comprising:
a polyolefin component comprising foamable polyethylene;
homogeneously dispersed in at least some of the polyolefin component, a fluoropolymer component comprising an acrylic-modified fluoropolymer; and
homogeneously dispersed in at least some of the polyolefin component, a blowing agent component comprising an azodicarbonamide blowing agent
   wherein the masterbatch composition is provided as a plurality of particles suitable for feeding to an extruder, and
   wherein the bulk foamable polyolefin composition is provided as a plurality of particles suitable for feeding to an extruder.

According to an aspect of some embodiments of the present invention, there is provided a polymer film, made of a polymer blend composition as disclosed herein, the polymer film being a foam and having a surfaced with increased hydrophobicity.

According to some embodiments, the polymer film is between 3 micrometers and 500 micrometers thick.

According to some embodiments, the polymer film comprises blowing agent residue.

According to some embodiments, the polymer film comprises:
polyethylene;
homogeneously dispersed in said polyethylene, a fluoropolymer component comprising an acrylic-modified fluoropolymer; and
blowing agent residue, comprising residue of an azodicarbonamide blowing agent.

According to some embodiments, the polymer film is prepared from a polymer blend composition selected from the group consisting of:

a) 0.1%-20% (w/w) fluoropolymer in LDPE; and from about 0.1% to about 6% (w/w) of a mixed exothermic/endothermic blowing agent;

b) 0.1%-20% (w/w) fluoropolymer in LDPE; and about 0.1% (w/w) of an exothermic blowing agent;

c) from about 1% to about 40% fluoropolymer in LDPE; and about 0.1% to about 6% of an endothermic blowing agent; and

d) 0.1%-20% fluoropolymer in LDPE; and about 0.2% to about 5% of an endothermic blowing agent, and from about 0.1% to about 6% of a nucleator.

According to an aspect of some embodiments of the present invention, there is provided a composite structure, comprising:
a substrate; and
distinct from said substrate, a polymer film as disclosed herein,
   wherein said polymer film defines at least one increased-hydrophobicity surface of the composite structure.

According to some embodiments, the composite structure is a multilayer polymer sheet having at least two layers, at least one of the two outer layers of the polymer sheet being said polymer film.

According to some embodiments, the composite structure comprises a multilayer polymer sheet, comprising:
as a substrate, a single layer comprising a combination of at least 95% by weight of a polyethylene selected from the group consisting of LDPE, LLDPE and combinations thereof; and
in contact with one or both sides of said substrate layer and defining an outer surface of said polymer sheet, a polymer film as disclosed herein.

According to an aspect of some embodiments of the present invention there is provided a method of preparing a composite structure having at least one surface having increased hydrophobicity, the method comprising the steps of:
i. providing a polymer blend as disclosed herein; and
ii. melting and applying said molten polymer blend as a layer onto at least one surface of a substrate under conditions that initiate gas generation from a blowing agent component of said polymer blend as gas bubbles in said molten polymer blend;
iii. allowing said applied molten polymer blend layer to solidify, thereby forming a polymer film when said molten polymer blend solidifies, said polymer film having a rough surface with physical features that impart increased hydrophobicity to said surface.

According to an aspect of some embodiments of the present invention there is provided a method of preparing a composite structure having at least one surface having increased hydrophobicity, the method comprising the steps of:
i. providing a polymer blend as disclosed herein; and
ii. melting said polymer blend and forming a film from said molten polymer under conditions that initiate gas generation from a blowing agent component of said polymer blend as gas bubbles in said molten polymer blend;
iii. allowing the formed film to solidify, thereby forming a polymer film, the polymer film having a rough surface with physical features that impart increased hydrophobicity to the surface; and
iv. attaching said formed polymer film to at least one surface of a substrate.

According to some embodiments, the method further comprises: subsequent to said solidifying of said molten polymer blend, removing an upper portion of a surface of said polymer film, leaving a rough surface having said increased hydrophobicity.

### BRIEF DESCRIPTION OF THE FIGURES

Some embodiments of the invention are described herein with reference to the accompanying figures. The description, together with the figures, makes apparent to a person having ordinary skill in the art how some embodiments of the invention may be practiced. The figures are for the purpose of illustrative discussion and no attempt is made to show structural details of an embodiment in more detail than is necessary for a fundamental understanding of the invention. For the sake of clarity, some objects depicted in the figures are not to scale.

In the Figures:

FIGS. 1A-1F schematically depict composite structures of the teachings herein that are multilayer sheets having a single polymer film according to the teachings as an outer layer defining a first surface of the polymer sheet;

FIGS. 2A-2E schematically depict composite structures of the teachings herein that are multilayer sheets having a first polymer film according to the teachings as a first outer layer defining a first surface of the polymer sheet and a second polymer film according to the teachings herein as a second outer layer defining a second surface of the polymer sheet;

FIGS. 3A-3H reproduce scanning electron micrograph images of the surfaces of experimentally-made films, including polymer films prepared in accordance with the principles of the present invention; and

FIGS. 4A-4B are bar graphs showing static angles of the surfaces of experimentally-made films, including polymer films prepared in accordance with the principles of the present invention.

### DETAILED DESCRIPTION OF EMBODIMENTS OF THE INVENTION

Aspects of the invention disclosed herein relate to:
a polymer blend for preparing polyolefin-based products;
a masterbatch composition for preparing the polymer blend;
a polymer film made of the polymer blend having a surface with increased hydrophobicity at least partially because the polymer film is a foam;
a composite structure (such as a coextruded polymer sheet) comprising the polymer film; and
a method of making the composite structure.

The Inventors disclose herein a polymer blend that can be used for preparing polyolefin-based products having a surface with increased hydrophobicity.

As known to a person having skill in the art, hydrophobicity of a surface is determined by placing a droplet of water on the surface and measuring the static contact angle, being the angle the droplet makes with the surface at the droplet/surface interface when the surface is flat and perpendicular to the gravity vector. A flatter drop has a lower contact angle indicating that the surface has lesser hydrophobicity and a rounder drop has a higher contact angle indicating that the surface has greater hydrophobicity. Generally, if the contact angle is less than 90° the surface is considered hydrophilic, greater than 90° the surface is considered hydrophobic and greater than 150° the surface is considered superhydrophobic. As used herein, the term ‘increased hydrophobicity’ and variants thereof refers to a surface of a polymer film according to the teachings herein having a static contact angle which is at least 10° greater than that of a reference surface. As used herein, the term ‘reference surface’ is the surface of a reference polymer film which is not foamed, prepared under identical conditions as the polymer film, from a reference polymer blend that is identical to the polymer blend from which the polymer film is made, except that the reference polymer blend is devoid of a blowing agent.

The Inventors further disclose a masterbatch that can be diluted to prepare the polymer blend. As is known to a person having ordinary skill in the art, a masterbatch can be considered a concentrated form of the polymer blend which is made therefrom. A masterbatch is commercially important as it allows efficient storage and transport of additives from which to make a polymer blend having desired properties.

The Inventors further disclose that the hydrophobicity of a polyolefin-based surface can be increased by blending a foamable polyolefin with at least one fluoropolymer and at least one blowing agent which is non-gaseous prior to activation by the application of heat to make polymer blend. During the manufacture of a polymer film from the polymer blend, the blowing agent produces bubbles so that the resulting polymer film is a foam having a rough surface with microscale and nanoscale physical features thereupon, the roughness imparting increased hydrophobicity to the surface. The hydrophobicity of the surface is further increased by the presence of the fluoropolymer in the polymer blend.

### Masterbatch

According to an aspect of some embodiments of the teachings herein, there is provided a masterbatch composition suitable for use in preparing a polymer film having a surface with increased hydrophobicity, the masterbatch composition comprising:

a foamable polyolefin component comprising at least one foamable polyolefin;

a fluoropolymer component comprising at least one fluoropolymer; and

a blowing agent component comprising at least one heat-activated blowing agent which is

non-gaseous prior to activation by the application of heat,

wherein fluoropolymer component is homogeneously dispersed in at least some the foamable polyolefin component, and
wherein the masterbatch is in a form suitable for use as extruder feed.

In some embodiments, the masterbatch composition is in the form of a plurality of particles (e.g., pellets, flakes, granules, beads, nurdles and powders) suitable for feeding to an extruder and are therefore are in a form suitable for use as extruder feed. Alternatively, in some embodiments, the masterbatch composition is in a bulk form (e.g., a sheet, a rod, an ingot) that can be comminuted to yield a plurality of particles suitable for feeding to an extruder and are therefore in a form suitable for use as extruder feed.

In some embodiments, the masterbatch is in the form of a plurality of particles and includes at least two different types of particles: particles comprising the blowing agent component; and particles of the fluoropolymer component homogeneously dispersed in at least some of the foamable polyolefin component. In some such embodiments, the particles comprising blowing agent component comprise particles of blowing agent component homogeneously dispersed in at least part of the foamable polyolefin component. In some such embodiments, the two different types of particles are packaged separately (e.g., each type of particle in a different sack or barrel, together constituting a kit) and, for use, a user combines the two different types of particles from the different packages for use. Alternatively, in some such embodiments, the two different types of particle are packaged together (e.g., in the same sack or barrel), typically mixed together.

In some embodiments, the masterbatch is in the form of a plurality of particles and the blowing agent component is homogeneously dispersed in the foamable polyolefin component together with the fluoropolymer component. In some such embodiments, all of the plurality of particles comprise both the blowing agent component and the fluoropolymer component homogeneously dispersed in the foamable polyolefin. In preferred such embodiments, all of the plurality of particles making up the masterbatch have an identical composition.

In some embodiments, the polyolefin component makes up between 15% and 86% weight percent of the masterbatch composition.

In some embodiments, the fluoropolymer component makes up between 10% and 15% weight percent of the masterbatch composition.

In some embodiments, the blowing agent component makes up between 4% and 70% weight percent of the masterbatch composition.

In some embodiments, the foamable polyolefin component, the fluoropolymer component and the blowing agent component together comprise not less than 90% by weight of the masterbatch composition. In preferred embodiments, the three components comprise not less than 93%, not less than 96% and even not less than 98% of the masterbatch composition.

### Polyolefin Component

The masterbatch composition comprises a polyolefin component comprising at least one foamable polyolefin. As used herein, the term “foamable polyolefin” refers to a polyolefin which is capable of foaming under suitable conditions.

In some embodiments, the polyolefin component makes up between 15% and 86% weight percent of the masterbatch composition.

The polyolefin component comprises any suitable single foamable polyolefin or combination of two or more foamable polyolefins.

Preferably, less than 5% by weight of the polyolefin component is cross-linked, even more preferably less than 4%, less than 3% and even less than 2%.

Preferably, at least 90% by weight of the polyolefin component is thermoplastic, and even more preferably at least 92%, 94% and even 96%.

In preferred embodiments, the polyolefin component is at least 90% by weight of a foamable polyolefin selected from the group consisting of polyethylene (PE), polypropylene (PP), and combinations thereof. In preferred embodiments, the polyolefin component is either at least 95% by weight PE or at least 95% by weight PP.

Any type of foamable PE can be used as a component of the polyolefin component of the masterbatch composition including LDPE, LLDPE, MDPE, HDPE and combinations thereof. In some embodiments, at least 90% by weight of the PE present in the polyolefin component is linear PE.

Any type of foamable PP can be used as a component of the polyolefin component of the masterbatch composition including PP homopolymers, PP random copolymers, and combinations thereof.

### Fluoropolymer Component

The masterbatch composition comprises a fluoropolymer component comprising at least one fluoropolymer homogeneously dispersed in at least some of the polyolefin component. The fluoropolymer is dispersed in the polyolefin component as a plurality of discrete entities. The specific type of entity depends on the exact identities of the fluoropolymer and the polyolefin, for example, in some embodiments, the fluoropolymer is present as an entity selected from the group consisting of particles, rods and fibrils.

The fluoropolymer component comprises any suitable single fluoropolymer or combination of two or more fluoropolymers. In some embodiments, at least one of the fluoropolymers is selected from the group consisting of a fluoro homopolymer, a fluoro copolymer, a fluoroelastomer, an acrylic-modified fluoropolymer (e.g., an acrylic-modified perfluoropolymer) or a combination thereof.

In some embodiments, the fluoropolymer component is at least 90% by weight (and in some embodiments, at least 93%, at least 95%, at least 98% and even at least 99% by weight) of a fluoropolymer selected from the group consisting of polytetrafluoroethylene (PTFE), an acrylic-modified fluoropolymer; acrylic-modified PTFE; chlorofluorocarbon (CFC); hydrochlorofluorocarbon (HCFC); and combinations thereof.

In preferred embodiments, the fluoropolymer component comprises at least 50% by weight of an acrylic-modified fluoropolymer, and even more preferably at least 60%, at least 70%, at least 80% and even at least 90%. In some such embodiments, the fluoropolymer component comprises at least 50% by weight of acrylic-modified PTFE, and even more preferably at least 60%, at least 70%, at least 80% and even at least 90% by weight of the acrylic-modified PTFE.

The fluoropolymer component of the masterbatch composition makes up any suitable proportion of the masterbatch composition. In some embodiments, the fluoropolymer component makes up from about 10% to about 15% by w/w of the total masterbatch composition.

### Blowing Agent

The masterbatch composition comprises a blowing agent component comprising at least one heat-activated blowing agent, in some embodiments homogeneously dispersed in at least part of the polyolefin component. A heat-activated blowing agent is a blowing agent that is non-gaseous prior to activation by the application of heat at which time the blowing agent produces a gas, in some embodiments due to decomposition of at least one component of the blowing agent and/or due to a chemical reaction of at least two components of the blowing agent. In the art, blowing agents are also known as foaming agents and pneumatogens. Under the right conditions, as a polymer composition emerges from an extrusion die, the gas produced by the blowing agent expands as multiple bubbles so that the extrudate becomes a foam.

In some embodiments, the blowing agent is a solid. In some embodiments, the blowing agent is a liquid.

The blowing agent component of the masterbatch composition makes up any suitable proportion of the masterbatch composition. In some embodiments, the blowing agent component makes up from about 4% to about 70% by w/w of the total masterbatch composition.

Any suitable single blowing agent or combinations of blowing agents may be used. In some embodiments, at least one blowing agent is selected from the group consisting of an endothermic, an exothermic or a combined endothermic/exothermic blowing agent.

In some embodiments, the blowing agent component comprises, and even consists of, at least one endothermic blowing agent. In some embodiments, an endothermic blowing agent comprises a combination of a base (e.g., sodium bicarbonate) and an acid (e.g., citric acid). Such blowing agents typically release carbon dioxide or water vapor when heated to temperatures of at least 120° C. In some embodiments, the blowing agent component comprises a blowing agent that is a solid mixture of an inorganic carbonate powder and an acid salt derived from a weak acid that when heated (for example, in a extruder) react to form carbon dioxide as disclosed in U.S. Pat. No. 8,563,621, which is hereby incorporated by reference in its entirety. In some such embodiments, the inorganic carbonate powder is a nanoparticulate carbonate powder with an average diameter of not more than 0.7 micrometers. In preferred such embodiments, the inorganic carbonate powder is an alkaline earth metal carbonate powder such as CaCO3. In some such embodiments, the acid salt derived from a weak acid is an alkaline metal acid salt such as sodium citrate.

In some embodiments, the blowing agent component comprises, and even consists of, at least one exothermic blowing agent. In some embodiments, an exothermic blowing agent is selected from the group consisting of azo blowing agents, hydrazide blowing agents, semi-carbazide blowing agents and nitroso blowing agents including azobisisobutyronitrile, azodicarbonamide, p-toluenesulfonyl hydrazide, oxybissulfohydrazide, 5-phenyl tetrazol, benzoylsulfohydroazide, p-toluoylsulfonylsemicarbazide, 4,4′-oxybis(benzenesulfonyl hydrazide), 5-phenyltetrazole, p-toluylensulfonyl-hydrazide, derivative thereof and combinations thereof. Such blowing agents typically release nitrogen or ammonia gas when heated to temperatures of at least 100° C.

Suitable commercially-available blowing agents include Hydrocerol® (Clariant AG, Muttenz, Switzerland), OnCap™ (PolyOne, Avon Lake, Ohio, USA), Celogen® (Galata Chemicals LLC., Hahnville, La., USA) including Celogen® 754A, 765A, 780, AZ, AZ-130, AZ1901, AZ760A, AZ5100, AZ9370, AZRV, all of which are azodicarbonamide types. Celogen®OT and TSH-C are useful sulfonylhydrazide blowing agents.

In some embodiments, a preferred blowing agent component comprises, and even consists of, an azodicarbonamide blowing agent. In some embodiments, a preferred blowing agent component comprises, and even consists of a sodium bicarbonate/citric acid blowing agent. In some embodiments, a preferred blowing agent component comprises, and even consists of, a combination of an azodicarbonamide blowing agent and a sodium bicarbonate/citric acid blowing agent, for example a blowing agent component consisting of 70-75% (e.g., 72.6%) azodicarbonamide, 20-26% (e.g., 24.2%) sodium bicarbonate and 1-6% (3.2%) citric acid (w/w).

### Nucleator Component

In some embodiments, the masterbatch composition further comprises a nucleator component, in some embodiments in the form of a plurality of particles as described above. A nucleator component is a component which helps with the formation of the desired size (typically, between 3 micrometers and 500 micrometers) and/or distribution of gas bubbles formed in a polymer blend by gas produced by a blowing agent. In some embodiments, a nucleator component is a particulate component dispersed in at least some of the polyolefin component of the masterbatch component.

In such embodiments, any suitable amount of nucleator component may be present in the masterbatch composition. In some embodiments, a nucleator component makes up between 0.05% and 10% weight percent of a masterbatch composition, in some embodiments, not more than 5%, not more than 3% and in some embodiments even not more than 2% weight percent of the masterbatch composition.

In some embodiments, the foamable polyolefin component, the fluoropolymer component, the blowing agent component and the nucleator component together comprise not less than 90% by weight of the masterbatch composition. In preferred embodiments, the three components comprise not less than 93%, not less than 96% and even not less than 98% of the masterbatch composition.

In some embodiments, the masterbatch is in the form of a plurality of particles as described above, the plurality of particles of the masterbatch includes at least three different types of particles: particles comprising the nucleator, particles comprising the blowing agent component as described above; and particles of the fluoropolymer component homogeneously dispersed in foamable polyolefin component as described above. In some such embodiments, the particles comprising nucleator component comprise particles of nucleator component homogeneously dispersed in foamable polyolefin component. In some such embodiments, the three different types of particles are packaged separately (e.g., each type of particle in a different sack or barrel, together constituting a kit) and, for use, a user combines the three different types of particles for use. Alternatively, in some such embodiments, two of the three different types of particles are packaged together (e.g., in the same sack or barrel, typically mixed together) and the third of the three different types of particles is packed separately from the other two types. Alternatively, in some such embodiments, the three different types of particle are packaged together (e.g., in the same sack or barrel), typically mixed together.

In some embodiments, the plurality of particles of the masterbatch includes at least two different types of particles: particles comprising the blowing agent component; and particles of the fluoropolymer component homogeneously dispersed in foamable polyolefin component, where the nucleator component is either homogeneously dispersed in one of the two types of particles together with either the blowing agent component or the fluoropolymer component or homogeneously dispersed in both of the two types of particles (i.e., together with the blowing agent component in one type of particle and together with the fluoropolymer component in a different type of particle). In some such embodiments, the two different types of particles are packaged separately (e.g., each type of particle in a different sack or barrel) and, for use, a user combines the two different types of particles for use. Alternatively, in some such embodiments, the two different types of particle are packaged together (e.g., in the same sack or barrel), typically mixed together.

In some embodiments, the nucleator component and the blowing agent component are both homogeneously dispersed in the foamable polyolefin component together with the fluoropolymer component. In some such embodiments, all of the plurality of particles comprise nucleator component, blowing agent component and fluoropolymer component homogeneously dispersed in the foamable polyolefin. In preferred such embodiments, all of the plurality of particles have an identical composition.

Any suitable nucleator component may be used. In some embodiments, the nucleator component is a single nucleator. In some embodiments, the nucleator component is a combination of two or more different nucleators. In some embodiments, a nucleator of the nucleator component is selected from the group consisting of β crystal nucleators, aromatic carboxylic acids and their salts (e.g., sodium benzoate, metal salts of hexahydrophthalic acid (HHPA), especially the calcium salt thereof which is a β crystal nucleator commercially available as Hyperform® HPN-20E and also Hyperform® HPN-68L (bicyclo[2.2.1]heptane-2,3-dicarboxylic acid disodium salt) both from Milliken&Co, Spartanburg, S.C., USA), sorbitol-based nucleating agents (e.g., dibenzylidene sorbitol (DBS)), talcs, kaolins, clays, modified clays, nanoclays (e.g., Cloisite® NA, 10A, 15A, 25A, 30B and 93A), silicates, salts of hexahydrophthalic acid, montmorillonites, smectites, bentonites, nanoclays, metal salts of hexahydrophthalic acid, calcium hexahydrophthalic acid, disodium cis-endo-bycyclo (2,2,1) heptane-2-3-dicarboxylate 13-docosenamide and mixtures thereof.

### Embodiment of Masterbatch Composition

A preferred embodiment of a masterbatch composition comprises:
a polyolefin component comprising foamable polyethylene;
homogeneously dispersed in at least some of the polyolefin component, a fluoropolymer component comprising an acrylic-modified fluoropolymer (in some embodiments, an acrylic-modified perfluoropolymer such as acrylic-modified PTFE); and
homogeneously dispersed in at least some of the polyolefin component, a blowing agent component comprising an azodicarbonamide blowing agent,
wherein the masterbatch has a form suitable for use as extruder feed.

In some preferred embodiments, the polyolefin component comprises at least 90% by weight of foamable polyethylene.

In some preferred embodiments, the masterbatch is in the form of a plurality of particles suitable for feeding to an extruder. In some such embodiment the plurality of particles consist of a single type of particle in which both the fluoropolymer and the blowing agent are dispersed in the polyolefin composition. In some such embodiments, the plurality of particles comprise, and in some embodiments consist of, two different types of particles: one type of particle including the fluoropolymer component dispersed in at least some of the polyolefin component and a different type of particle including the blowing agent component (preferably dispersed in at least some the polyolefin component).

### Polymer Blend Composition

According to an aspect of some embodiments of the teachings herein, there is also provided a polymer blend composition useful for preparing a polymer film having a surface with an increased hydrophobicity according to the teachings herein. The polymer blend comprises the equivalent of between 1 and 30% by weight of the components of the masterbatch composition recited above (a polyolefin component; a fluoropolymer component, a blowing agent component and, optionally, a nucleator component) together with between 70% and 99% by weight bulk foamable polyolefin.

In some embodiments, the masterbatch and the bulk foamable polyolefin together make up not less than 90%, not less than 95%, not less than 97%, not less than 99% and even not less than 99.9% of the polymer blend.

A polymer blend may be made in any suitable manner.

In preferred embodiments, the polymer blend is made by mixing a masterbatch composition as described above with a desired amount of bulk foamable polyolefin. In such embodiments, between 1 and 30% by weight of a masterbatch composition as recited above is mixed with between 70% and 99% by weight bulk foamable polyolefin.

In some alternate embodiments, a polymer blend is made de novo by combining the separate components. In such embodiments, the relative amounts of the different components is the same as for embodiments where the masterbatch is diluted. For brevity, the relative amounts are not recited here but a person having ordinary skill in the art is able to calculate the relative amounts of the various blend components using simple arithmetic.

In some embodiments, the polymer blend is provided as a plurality of particles having identical compositions, the particles suitable for feeding to an extruder, as discussed above.

Alternatively, in some embodiments, the polymer blend is provided as a mixture of plurality of particles of different types, each type of particle having a different composition, the particles suitable for feeding to an extruder, as discussed above. Such a mixture of particles can be made in any suitable vessel, for example, in the hopper of an extruder.

For example, in some such embodiments a polymer blend comprises (or consists) of a first particle type that comprises the bulk foamable polyolefin and one or more additional particle types that together constitute a masterbatch composition as described above. In some embodiments, the foamable polyolefin of the masterbatch and the bulk foamable polyolefin are the same. In some embodiments, the foamable polyolefin of the masterbatch and the bulk foamable polyolefin are different.

### Dilution of the Masterbatch Composition

As noted above, typically the polymer blend composition comprises the equivalent of between 1 and 30% by weight of the components of the masterbatch composition recited above together with between 99% and 70% by weight bulk foamable polyolefin.

In some embodiments, the proportion of bulk foamable polyolefin to masterbatch composition is such that the polymer blend composition comprises between not less 0.1% and not more than 10% fluoropolymer component. In some embodiments, the proportion is such that the polymer blend composition comprises not less than 0.5%, not less than 1% and even not less than 1.5% fluoropolymer component. In some embodiments, the proportion is such that the polymer blend composition comprises not more than 8%, not less than 6% and even not less than 5% fluoropolymer component.

Additionally or alternatively, in some embodiments, the proportion of bulk foamable polyolefin to masterbatch composition is such that the polymer blend composition comprises not less than 80% and even not less than 85% by weight foamable polyolefin (i.e., sum of the polyolefin component of the masterbatch and bulk foamable polyolefin of the polymer blend).

Additionally or alternatively, in some embodiments, the proportion of bulk foamable polyolefin to masterbatch composition is such that the polymer blend composition comprises not more than 10% by weight inorganic particles (i.e., sum of inorganic blowing agent components, inorganic nucleators (if present) and other inorganic particles).

### Bulk Foamable Polyolefin

A polymer blend composition includes a bulk foamable polyolefin.

The bulk foamable polyolefin comprises any suitable single foamable polyolefin or combination of two or more foamable polyolefins.

Preferably, less than 5% by weight of the bulk foamable polyolefin is cross-linked, even more preferably less than 4%, less than 3% and even less than 2%.

Preferably, at least 90% by weight of the bulk foamable polyolefin is thermoplastic, and even more preferably at least 92%, 94% and even 96%.

In preferred embodiments, the bulk foamable polyolefin is at least 90% by weight of a foamable polyolefin selected from the group consisting of polyethylene (PE), polypropylene (PP), polyvinyl chloride and combinations thereof. In preferred embodiments, the bulk foamable polyolefin is either at least 95% by weight PE or at least 95% by weight PP.

Any type of foamable PE can be used as a component of the bulk foamable polyolefin including LDPE, LLDPE, MDPE, HDPE and combinations thereof. In some embodiments, at least 90% by weight of the PE present in the bulk foamable polyolefin is linear PE.

Any type of foamable PP can be used as a component of the bulk foamable polyolefin including PP homopolymers, PP random copolymers, and combinations thereof.

In some embodiments, the composition of the bulk foamable polyolefin is identical to the composition of the polyolefin component of the masterbatch composition. Alternatively, in some embodiments, the composition of the bulk foamable polyolefin is different from the composition of the polyolefin component of the masterbatch composition.

### Embodiment of a Polymer Blend Composition

A preferred embodiment of a polymer blend composition comprises:

as a bulk foamable polyolefin, polyethylene (preferably LDPE, LLDPE and combinations thereof); and

a masterbatch composition comprising:
a polyolefin component comprising foamable polyethylene;
homogeneously dispersed in at least some of the polyolefin component, a fluoropolymer component comprising an acrylic-modified fluoropolymer (in some embodiments, an acrylic-modified perfluoro polymer such as acrylic-modified PTFE); and
homogeneously dispersed in at least some of the polyolefin component, a blowing agent component comprising an azodicarbonamide blowing agent
   wherein the masterbatch composition is provided as a plurality of particles suitable for feeding to an extruder, and
   wherein the bulk foamable polyolefin composition is provided as a plurality of particles suitable for feeding to an extruder.

### Polymer Film Made of the Polymer Blend

According to an aspect of some embodiments of the teachings herein, there is also provided a polymer film made of the polymer blend according to the teachings herein, the polymer film being a foam and having a surface with increased hydrophobicity.

The polymer film is any suitable thickness. In some embodiments, the polymer film is between 3 micrometers and 500 micrometers thick. In preferred embodiments, the polymer film is not more than 300 micrometers thick, not more than 200 micrometers thick and even not more than 100 micrometers thick.

In preferred embodiments, the polymer film is made by extrusion of the polymer blend composition according to the teachings herein and therefore has a composition of about 1%-30% by weight of the components of the masterbatch composition recited above (a polyolefin component; a fluoropolymer component; and residue of a blowing agent component) and about 70%-90% by weight bulk foamable polyolefin as recited above. For brevity, the relative amounts are not recited here but a person having ordinary skill in the art is able to calculate the relative amounts of the various blend components using simple arithmetic.

In some embodiments, the polymer film comprises between not less 0.1% and not more than 10% fluoropolymer component. In some embodiments, the proportion is such that the polymer film comprises not less than 0.5%, not less than 1% and even not less than 1.5% fluoropolymer component. In some embodiments, the polymer film comprises not more than 8%, not less than 6% and even not less than 5% fluoropolymer component.

Additionally or alternatively, in some embodiments, the polymer film comprises not less than 80% and even not less than 85% by weight polyolefin.

Additionally or alternatively, in some embodiments, polymer film comprises not more than 10% by weight inorganic particles (i.e., sum of inorganic blowing agent component residue, inorganic nucleators (if present) and other inorganic particles).

### Increased Hydrophobicity

In some embodiments, a polymer film according to the teachings herein has a rough surface with nanoscale and microscale features that increase the hydrophobicity of the polymer film. In some such embodiments, the nanoscale and/or microscale features are craters formed by the escape of bubbles of gas released by the blowing agent.

During extrusion of the polymer blend composition to form the polymer film, the blowing agent is activated by the heat of the extruder to generate a gas inside the molten polymer blend.

In some embodiments when the still-molten blend leaves the extruder die forming an incipient film and a surface of the incipient film is exposed to air or other gas, bubbles near a surface of the incipient film burst as the film cools. Craters are formed by the bursting bubbles and remain on the surface when the incipient film cools and eventually solidifies, so that the surface of the resulting polymer film is rough, having nanoscale and microscale features that increase the hydrophobicity of the polymer film. Thus, in some embodiments the increased hydrophobicity of the polymer film surface is at least partially caused by nanoscale and/or microscale features that include craters formed by the escape of bubbles of gas released by the blowing agent.

In some alternate embodiments, the polymer blend is coextruded with at least two additional layers: a bonding layer in contact with the polymer blend and a backing layer contacting the bonding layer. When the still-molten blend leaves the extruder die forming an incipient polymer film, bubbles are formed inside the incipent polymer film as the blend cools, in some embodiments also at the incipient polymer film/bonding layer boundary. After the polymer blend, bonding layer and backing layer cool and solidify, the bonding layer and backing layer are separated from the now-formed polymer film by peeling. The separation occurs by cohesive failure of the polymer film so that some of the polymer film layer is detached from the rest of the polymer film and remains as a residue adhering to the bonding layer. Without wishing to be held to any one theory, it is currently believed that the internal cohesion of the polymer film is relatively low due to the combination of the presence of the discrete fluoropolymer dispersed in the polymer film and the presence of bubbles produced by the blowing agent in the polymer film. As a result of the cohesive failure of the polymer film (which leaves a rough surface), of craters are formed from bubbles ripped-apart by the separation and of the presence of the fluoropolymer at the now-exposed surface, the surface of the resulting polymer film is rough, having nanoscale and microscale features that increase the hydrophobicity of the polymer film. As demonstrated experimentally, in some embodiments even to superhydrophobicity. Accordingly, in some embodiments, a polymer film according to the teachings herein has a rough surface with nanoscale and microscale features that increase the hydrophobicity of the polymer film. In some such embodiments, the nanoscale and/or microscale features are formed by the cohesive failure of the polymer film and by craters formed by ripping apart gas bubbles inside the polymer film.

### Post-Cooling Peeling

In some embodiments, subsequent to extrusion and cooling of the film, an upper portion of the surface of a polymer film is removed, for example, by a peeling process that leads to cohesive failure of the polymer film (called cohesive failure peeling), substantially as described immediately hereinabove. As used herein, peeling and cohesive failure peeling are synonomous with terms such as “cohesion peel-seal film ripping”, “cohesion peel seal film”, “cohesion peel seal”, “peel seal ripping” and “peel seal” for example as used in the priority document.

For example, in some embodiments a peeling sheet is separately made by coextrusion including a bonding layer and a backing layer. The rough surface (formed by escape of gas from the surface) of a polymer film as described above is bonded with the bonding layer of the peeling sheet. The peeling sheet is then separated from the polymer film by peeling. The separation of the film layer occurs by cohesive failure of the film layer as described above, with results as described above so that in some such embodiments, the nanoscale and/or microscale features on the surface of the polymer sheet are formed by the cohesive failure of the polymer film and by craters formed by ripping apart gas bubbles inside the polymer film.

In embodiments where an upper portion of the surface of the polymer sheet is removed by peeling using a peeling sheet, the bonding layer of the peeling sheet is bonded to the surface of the polymer sheet by the application of heat (e.g., a batch process analogous to heat sealing or a continuous process such as hot lamination).

### Blowing Agent Residue

Blowing agents are typically solids or liquids that under the conditions that the polymer film is made, generate a gas. Although some of the generated gas escapes the polymer film when a bubble bursts, typically at least some gas remains trapped in the polymer film so that the polymer film is a foam. In some embodiments, the polymer film is an open-cell foam. In some embodiments, the polymer film is a closed-cell foam. In some embodiments, the polymer film is a combined open-cell/closed-cell foam.

In some embodiments, the polymer film comprises a blowing agent residue in the polymer film.

In some embodiments, the polymer film comprises a blowing agent residue that is a gas and/or liquid trapped in bubbles inside the polymer film.

Some blowing agents, subsequent to release of a gas, also leave a solid or liquid residue that is trapped in the polymer film, so that in some embodiments, the polymer film comprises a blowing agent residue that is a solid and/or a liquid.

### Embodiment of a Preferred Polymer Film

A preferred embodiment of a polymer film is made by extrusion of a preferred polymer blend composition as recited above and comprises:

polyethylene (from the foamable bulk polyolefin and from the masterbatch composition, preferably LDPE, LLDPE and combinations thereof);
homogeneously dispersed in the polyethylene, a fluoropolymer component comprising an acrylic-modified fluoropolymer (in some embodiments, an acrylic-modified perfluoropolymer such as acrylic-modified PTFE); and
blowing agent residue, comprising residue of an azodicarbonamide blowing agent.

In some embodiments the polymer film is prepared from a polymer blend composition selected from the group consisting of:

a) 0.1%-20% (w/w) fluoropolymer in LDPE; and from about 0.1% to about 6% (w/w) of a mixed exothermic/endothermic blowing agent;

b) 0.1%-20% (w/w) fluoropolymer in LDPE; and about 0.1% (w/w) of an exothermic blowing agent;

c) from about 1% to about 40% fluoropolymer in LDPE; and about 0.1% to about 6% of an endothermic blowing agent; and

d) 0.1%-20% fluoropolymer in LDPE; and about 0.2% to about 5% of an endothermic blowing agent, and from about 0.1% to about 6% of a nucleator. In preferred embodiments, the fluoropolymer comprises, and in some embodiments consists of, an acrylic-modified fluoropolymer (e.g., acrylic-modified PTFE)

### Composite Structure Comprising the Polymer Film

According to an aspect of some embodiments of the teachings herein, there is also provided a composite structure comprising a substrate and, distinct from the substrate, a polymer film as described herein, wherein the polymer film defines at least one increased-hydrophobicity surface of the composite structure. As a result, the polymer film defines an increased-hydrophobicity surface of the composite structure.

### Thickness of the Polymer Film of the Composite Structure

The thickness of the polymer film that defines a surface of the composite structure is any suitable thickness. In some embodiments, the polymer film is between 3 micrometers and 500 micrometers thick. In preferred embodiments, the polymer film is not more than 300 micrometers thick, not more than 200 micrometers thick and even not more than 100 micrometers thick.

### Multilayer Polymer Sheet as a Composite Structure

In some embodiments the composite structure is a multilayer polymer sheet having at least two layers, at least one of the two outer layers being the polymer film according to the teachings herein and at least one additional layer of the polymer sheet being a substrate. Such a multilayer sheet is made in any suitable manner. In some preferred embodiments, such a multilayer sheet is made by coextrusion.

The thickness of the substrate of such a multilayer polymer sheet is any suitable thickness. In some embodiments, the substrate is between 30 micrometers and 1000 micrometers thick. In preferred embodiments, the substrate is not more than 900 micrometers thick, not more than 500 micrometers thick and even not more than 400 micrometers thick. In preferred embodiments, the substrate is not less than 40 micrometers thick and even not less than 60 micrometers thick.

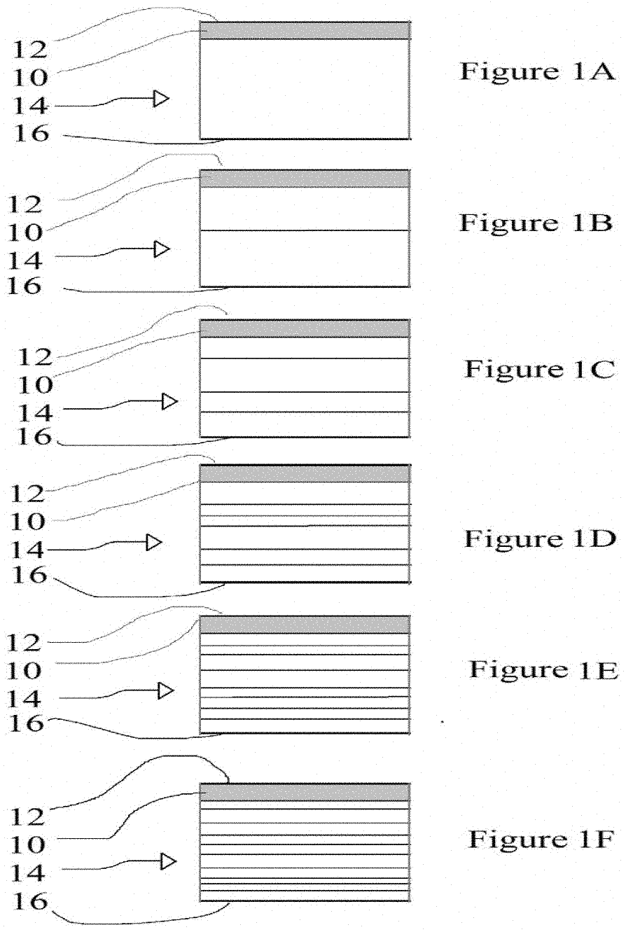

In some embodiments, the composite structure is a multilayer polymer sheet having an outer layer defining a first surface of the polymer sheet being the polymer film according to the teachings herein and a substrate defining a second surface of the polymer sheet. Such embodiments are schematically depicted in cross-section in FIGS. 1A-1F, where each depicted sheet has a polymer film 10 according to the teachings herein defining a first, increased-hydrophobicity, outer surface 12 and a substrate 14 defining a second outer surface 16 of the polymer sheet. Depending on the embodiments, the substrate comprises any suitable number of distinct polymer layers, e.g.,

in FIG. 1A, a two-layer sheet having a substrate with a single layer;

in FIG. 1B, a three-layer sheet having a substrate with two layers;

in FIG. 1C, a five-layer sheet having a substrate with four layers;

in FIG. 1D, a seven-layer sheet having a substrate with six layers;

in FIG. 1E, a nine-layer sheet having a substrate with five layers; and

in FIG. 1F, an eleven-layer sheet having a substrate with seven layers.

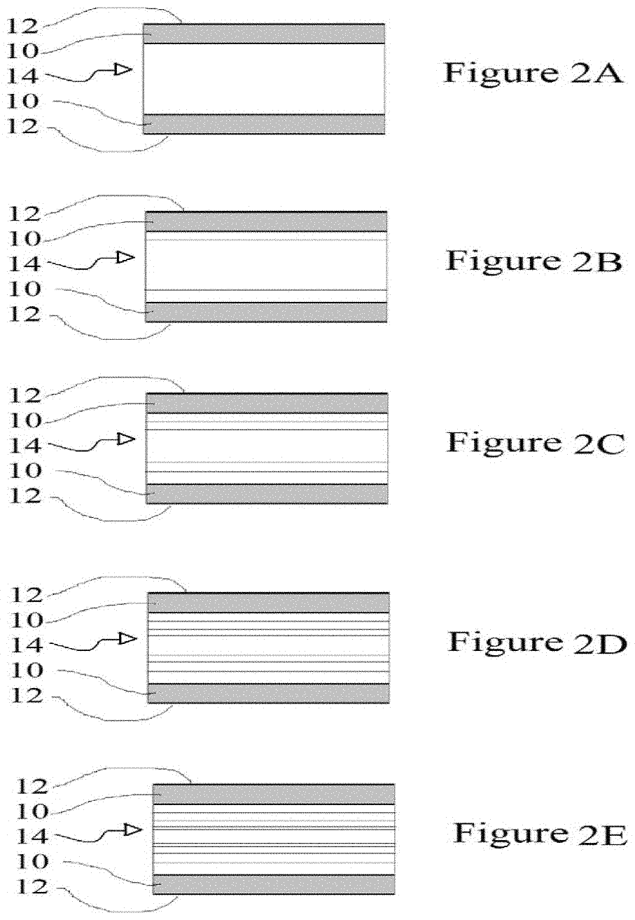

In some embodiments, the composite structure is a multilayer polymer sheet where both outer layers, each defining a surface of the polymer sheet, being a polymer film according to the teachings herein, with a substrate sandwiched therebetween. In some embodiments, both outer layers are polymer films according to the teachings herein with identical compositions. Alternatively, in some embodiments, the outer layers are polymer films according to the teachings herein having different compositions. Such embodiments are schematically depicted in cross-section in FIGS. 2A-2E, where each depicted sheet has two polymer films 10 according to the teachings herein defining the two, increased-hydrophobicity, outer surfaces 12 with a substrate 14 of the polymer sheet sandwiched therebetween. Depending on the embodiments, the substrate comprises any suitable number of distinct polymer layers, e.g.,

in FIG. 2A, a three-layer sheet having a substrate with one layer;

in FIG. 2B, a five-layer sheet having a substrate with three layers;

in FIG. 2C, a seven-layer sheet having a substrate with five layers;

in FIG. 2D, a nine-layer sheet having a substrate with seven layers; and

in FIG. 2E, an eleven-layer sheet having a substrate with nine layers.

In such embodiments, the composition of the layer contacting the polymer film is any suitable layer having sufficient compatibility with and adhesion to the polymer film.

The composition of the layer is any suitable single polymer or combination of two or polymers. In some embodiments, the layer comprises at least one member of the group of polymers consisting of polyethylene (PE, LDPE, LLDPE, MDPE, HDPE, mLLDPE), polypropylene (PP, PP homopolymers, PP random copolymers), polyvinyl chloride and combinations thereof. and combinations thereof.

### Embodiments of a Composite Structure

One preferred embodiment of a composite structure is a two- or three-layer polymer sheet, comprising:
as a substrate:
   a single layer comprising a combination of at least 95% by weight (preferably, at least 99% by weight) of a polyethylene selected from the group consisting of LDPE, LLDPE and combinations thereof; and
in contact with one (for the two-layer polymer sheet embodiment) or both (for the three layer polymer sheet embodiment) sides of the substrate and defining an outer surface of the polymer sheet, a preferred polymer film as described above.

In some such embodiments, the weight ratio of LDPE to LLDPE of about 30:70.

In some embodiments, the polymer film comprises between not less 0.1% and not more than 10% fluoropolymer component. In some embodiments, the proportion is such that the polymer film comprises not less than 0.5%, not less than 1% and even not less than 1.5% fluoropolymer component. In some embodiments, the polymer film comprises not more than 8%, not less than 6% and even not less than 5% fluoropolymer component. additionally or alternatively, in some embodiments, the polymer film comprises not less than 80% and even not less than 85% by weight polyolefin. Additionally or alternatively, in some embodiments, the polymer film comprises not more than 10% by weight inorganic particles (i.e., sum of inorganic blowing agent component residue, inorganic nucleators (if present) and other inorganic particles).

In some such embodiments, the composite structure is a two-layer polymer sheet. In some such embodiments, the substrate to polymer film thickness is between about 100:10 and 100:100 and even between about 100:10 and about 100:50. In some such embodiments, the substrate to polymer film thickness is about 100:30. In some such embodiments, the polymer film is about 30 micrometers thick and the substrate layer is about 100 micrometers thick. Alternatively or additionally, in some such two-layer polymer sheet embodiments the polymer film comprises between about 0.5% and about 10% (w/w) of the composite structure.

In some such embodiments, the composite structure is a 3-layer polymer sheet. In some such embodiments, the compositions of the first polymer film and the second polymer film are different. In preferred embodiments, the compositions of the first polymer film and the second polymer film are the same. In some such embodiments, the substrate to polymer film thickness is between about 100:10 and 100:100 and even between about 100:10 and about 100:50. In some such embodiments, the first polymer film to substrate to second polymer film thickness is about 30:100:30. In some such embodiments, the first polymer film and the second polymer film are about 30 micrometers thick and the substrate layer is about 100 micrometers thick. Alternatively or additionally, in some such embodiments, the first polymer film and the second polymer film each independently comprises between about 0.5% and about 10% (w/w) of the composite structure.

acrylic-modified

### Method of Making Composite Structure

As noted above, an aspect of the teachings herein is a composite structure comprising a substrate and at least one outer layer comprising a polymer film according to the teachings herein, the polymer defining an increased-hydrophobicity surface of the composite structure. Such a composite structure is made using any suitable method, for example, methods known in the art. Thus, according to an aspect of some embodiments of the teachings herein there is provided a method of preparing a composite structure having at least one surface having increased hydrophobicity, the method comprising the steps of:
i. providing a polymer blend as disclosed herein; and
ii. melting and applying the molten polymer blend as a layer onto at least one surface of a substrate under conditions that initiate gas generation from the blowing agent component of the polymer blend as gas bubbles in the molten polymer blend;
iii. allowing the applied molten polymer blend layer to solidify,
   thereby forming a polymer film when the molten polymer blend solidifies, the polymer film having a rough surface with physical features that impart increased hydrophobicity to the surface. As mentioned above, the physical features are microscale and nanoscale physical features.

In some embodiments, the rough surface of the polymer film having increased hydrophobicity is formed spontaneously during cooling, by gas bubbles that are at the surface or escape from the surface during cooling of the molten polymer blend.

Alternatively, in some embodiments, the rough surface of the polymer film having increased hydrophobicity is formed by removing an upper portion of the polymer film, for example, using a peeling process that leads to cohesive failure of the polymer layer (i.e., cohesive failure peeling). Accordingly, in some embodiments, the method further comprises subsequent to the solidifying of the molten polymer blend, removing an upper portion of the surface of a polymer film (in some embodiments, by cohesive failure peeling), leaving a rough surface (with nanoscale and microscale features) having the increased hydrophobicity.

The polymer blend is melted and applied molten as a layer on the at least one surface of the substrate in any suitable fashion. In some embodiments, the molten polymer blend is applied as a flat layer that is parallel to the substrate, e.g., the substrate is planar, and the molten polymer blend is applied as a flat layer. Alternatively, in some embodiments, the molten polymer blend is applied coaxially with the substrate, e.g., the molten polymer blend is applied as a tube that surrounds the substrate.

In some embodiments, the molten polymer blend is applied by extrusion as a layer onto a surface of the solid substrate, e.g., by extrusion coating or over-jacketing extrusion. In some such embodiments, the molten polymer blend is applied directly to the substrate surface. Alternatively, in some such embodiments, an adhesive or tie layer is applied to the surface of the solid substrate and the molten polymer blend is applied by extrusion to contact the adhesive or tie layer.

In some embodiments, the molten polymer blend is applied by extrusion as a layer onto a molten substrate, e.g., by coextrusion. Such embodiments are exceptionally useful for preparing a composite structure that is a multilayer polymer sheet.

In some alternate embodiments, the polymer film is first made and subsequently attached to a solid surface of a substrate. Thus, according to an aspect of some embodiments of the teachings herein there is provided a method of preparing a composite structure having at least one surface having increased hydrophobicity, the method comprising the steps of:
i. providing a polymer blend as disclosed herein; and
ii. melting the polymer blend and forming a film from the molten polymer (preferably by extrusion) under conditions that initiate gas generation from the blowing agent component of the polymer blend as gas bubbles in the molten polymer blend;
iii. allowing the formed film to solidify, thereby forming a polymer film, the polymer film having a rough surface with physical features that impart increased hydrophobicity to the surface; and
iv. attaching the formed polymer film to at least one surface of a substrate.

In some embodiments, the attaching of the formed polymer film is through an adhesive (e.g., a tie layer), specifically, attaching the formed polymer film comprises: providing a substrate with a surface; applying an adhesive to the surface; and contacting the formed polymer film with the adhesive applied to the surface.

In some embodiments, the attached of the formed polymer film is substantially extrusion-coating a formed polymer film with a fluid substrate precursor.

In some embodiments, the rough surface of the polymer film having increased hydrophobicity is formed spontaneously during cooling, by gas bubbles that are at the surface or escape from the surface during cooling of the molten polymer blend.

Alternatively, in some embodiments, the rough surface of the polymer film having increased hydrophobicity is formed by removing an upper portion of the polymer film, for example, using cohesive failure peeling. Accordingly, in some embodiments, the method further comprises subsequent to the solidifying of the molten polymer blend, removing an upper portion of the surface of a polymer film (in some embodiments, by a cohesive failure peeling), leaving a rough surface (with nanoscale and microscale features) having the increased hydrophobicity. In some embodiments, removal is performed prior to attaching the formed polymer sheet to a surface of the substrate. Alternatively, in some embodiments, removal is performed subsequent to attaching the formed polymer sheet to a surface of the substrate.

### Stretching Polymer Film

In some embodiments, the polymer film is stretched. In some embodiments, the stretching is monoaxial stretching. In some embodiments, the stretching is biaxial. Stretching is performed in any suitable fashion using any suitable device or combination of devices, for example, using known methods and conditions with standard technology with no special conditions required.

In embodiments where the polymer film is applied to a surface of a substrate as a molten polymer blend forming a composite structure that is a multilayer sheet, the polymer film is preferably stretched together with the entire composite structure.

In embodiments where a formed polymer film is attached to a surface of a non-stretchable substrate, the formed polymer film is stretched prior to attaching to the surface.

In embodiments where a formed polymer film is attached to a surface of a stretchable substrate (e.g., a separately formed polymer sheet), the formed polymer film is stretched either prior to attaching to the surface or subsequently to the attaching together with the substrate.

In some embodiments where a polymer film to be stretched is coextruded with a bonding layer and a backing layer to allow subsequent cohesive failure peeling, both the bonding layer and the backing layer are selected to be stretchable. In some such embodiments, the polymer film/bonding layer/backing layer laminate are stretched, and subsequently the bonding layer and backing layer are separated from the polymer film.

In some embodiments where a polymer film to be stretched is coextruded with a bonding layer and a backing layer to allow subsequent cohesive failure peeling, both the bonding layer and the backing layer are selected to be either stretchable or not stretachable. In some such embodiments, the bonding layer and backing layer are separated from the polymer film and the polymer film is subsequently stretched.

In some embodiments, a polymer film is first stretched, subsequently bonded to a stretchable or non-stretchable peeling sheet, and later the peeling sheet is separated from the polymer film.

In some embodiments, a stretchable peeling sheet is bonded to the polymer film, subsequently the peeling sheet/polymer film laminate is stretched, and later the stretched peeling sheet is separated from the stretched polymer film.

### Providing a Polymer Blend

In some embodiments, providing the polymer blend comprises providing the polymer blend as a plurality of particles having an identical composition, the particles suitable for feeding to an extruder (e.g., pellets, flakes, granules, beads and powders) as described above. In some such embodiments, the particles are placed in the hopper of an extruder for subsequent melting. In some such embodiments, the plurality of particles of polymer blend are made by: providing an amount of a masterbatch composition; and combining the amount of masterbatch composition with an amount of bulk foamable polyolefin, thereby providing the polymer blend. In some such embodiments, the amount of the masterbatch composition and the amount of the bulk foamable polyolefin is such that the polymer blend comprises between 1% and 30% by weight masterbatch and between 99% and 70% bulk foamable polyolefin. In some such embodiments, the provided masterbatch composition and the provided bulk foamable polyolefin are each provided as a plurality of particles having an identical composition, the combining is performed by mixing the particles in a vessel to form a particle mixture which is then processed to form the plurality of polymer blend particles having an identical composition. In such embodiments, the processing is performed under conditions that do not cause the blowing agent components to produce a gas.

In some embodiments, providing the polymer blend comprises:
providing an amount of a masterbatch composition; and
combining the amount of masterbatch composition with an amount of bulk foamable polyolefin,
   thereby providing the polymer blend.

In some such embodiments, the amount of the masterbatch composition and the amount of the bulk foamable polyolefin is such that the polymer blend comprises between 1% and 30% by weight masterbatch and between 99% and 70% bulk foamable polyolefin.

In some embodiments, the provided masterbatch composition and the provided bulk foamable polyolefins are each provided as a plurality of particles, the particles suitable for feeding to an extruder (e.g., pellets, flakes, granules, beads and powders) and the combining is performed by mixing the particles in a vessel to form a particle mixture. In some embodiments, the vessel is the hopper of an extruder. In some embodiments, the particle mixture is placed in the hopper of an extruder for subsequent melting.

In some embodiments, the composition of all of the particles of the bulk foamable polyolefin are identical. Alternatively, in some embodiments, there are at least two different types of particles making up the bulk foamable polyolefin, each one of the different types having a different composition (e.g., LDPE and LLDPE particles).

In some embodiments, the composition of all of the particles of the masterbatch are identical (i.e., include polyolefin, fluoropolymer, blowing agent and optionally a nucleator). Alternatively, in some embodiments there are at least two different types of particles making up the masterbatch, each one of the different types having a different composition (e.g., fluoropolymer dispersed in polyolefin particles, blowing agent particles (optionally dispersed in polyolefin), and optionally nucleator particles (optionally dispersed in polyolefin).

In accordance with some embodiments, there is provided a composition suitable for use in preparing a polyolefin-based product having a surface with increased hydrophobicity, the composition comprising at least one foamable polyolefin, at least one fluoropolymer and at least one blowing agent which is non-gaseous prior to activation by the application of heat.

In accordance with some embodiments, there is provided a masterbatch composition suitable for use in preparing a polyolefin-based product having a surface with increased hydrophobicity, the composition comprising at least one foamable polyolefin, at least one fluoropolymer and at least one heat-activated blowing agent which is non-gaseous prior to activation by the application of heat

wherein said at least one blowing agent is present at a concentration of from 4% to 70% w/w of the total composition,
wherein said at least one fluoropolymer comprises a fluoro elastomer; and
wherein said at least one foamable polyolefin and said at least one fluoropolymer together constitute a homogeneous polymeric blend.

In accordance with some embodiments, the at least one foamable polyolefin is selected from the group consisting of polyethylene, polypropylene and a combination thereof.

In accordance with some embodiments, the at least one fluoropolymer is selected from the group consisting of a fluoro homopolymer, a fluoro copolymer and a fluoro elastomer, or any combination thereof.

In accordance with some embodiments, the at least one fluoropolymer is selected from the group consisting of polytetrafluoroethylene (PTFE), acrylic-modified PTFE; chlorofluorocarbon (CFC); hydrochlorofluorocarbon (HCFC); and combinations thereof.

In accordance with some embodiments, the at least one blowing agent is an endothermic, exothermic or combined endothermic/exothermic blowing agent.

In accordance with some embodiments, the at least one blowing agent is present at a concentration of from about 4% to about 70% w/w of the total composition.

In accordance with some embodiments, the composition further comprises a nucleator.

In accordance with some embodiments, the nucleator is selected from the group consisting of β crystal nucleators, aromatic carboxylic acids and their salts, sorbitol-based nucleating agents, talcs, kaolins, clays, modified clays, nanoclays, silicates, salts of hexahydrophthalic acid, sodium benzoate, benzylidene sorbitol (DBS), montmorillonites, smectites, bentonites, nanoclays, metal salts of hexahydrophthalic acid, calcium hexahydrophthalic acid, disodium cis-endo-bycyclo (2,2,1) heptane-2-3-dicarboxylate 13-docosenamide and mixtures thereof.

In accordance with some embodiments, there is provided a blend suitable for use in preparing a polyolefin-based product having a surface with increased hydrophobicity, the blend comprising between 1 and 30% of the composition as disclosed herein, and between 70 and 99% by weight of a bulk foamable polyolefin.

In accordance with some embodiments, the at least one bulk foamable polyolefin comprises polyethylene, polypropylene or combinations thereof.

In accordance with some embodiments, the fluoropolymer is present at a concentration of from about 1% (w/w) to about 40% (w/w) of the total blend.

In accordance with some embodiments, there is provided a polymeric film having a surface with increased hydrophobicity, the film comprising between 1 and 30% of a composition comprising at least one polyolefin, at least one fluoropolymer and at least one blowing agent residue; and between 70 and 99% by weight of a bulk foamable polyolefin.

In accordance with some embodiments, there is provided a polymeric film having a surface with increased hydrophobicity, the film comprising between 1 and 30% of a composition comprising at least one polyolefin, at least one fluoropolymer and at least one blowing agent residue; and between 70 and 99% by weight of a bulk foamable polyolefin

wherein said at least one fluoropolymer comprises a fluoro elastomer;
wherein said at least one polyolefin and said at least one fluoropolymer together constitute a homogeneous polymeric blend, and
the surface of the film has increased hydrophobicity by virtue of a topography including an arrangement of surface nano and microstructures.

In accordance with some embodiments, the polymeric film has a thickness of between about 3 microns and 500 microns.

In accordance with some embodiments, there is provided a composite structure comprising a substrate and at least one outer layer comprising the polymeric film as disclosed herein.

In accordance with some embodiments, the at least one polyolefin in said at least one outer layer comprises polypropylene.

In accordance with some embodiments, the substrate comprises polypropylene.

In accordance with some embodiments, the substrate comprises a combination of LDPE and LLDPE and said at least one outer layer is formed from a blend comprising at least one polyethylene and acrylic modified perfluoro polymer or fluoro-elastomer and an azodicarbonamide blowing agent.

In accordance with some embodiments, there is provided a composite structure comprising a substrate and two outer layers, each outer layer comprising the polymeric film as disclosed herein.

In accordance with some embodiments, the composition structure is prepared by co-extrusion of said substrate and said two outer layers.

In accordance with some embodiments, the substrate comprises low density polyethylene (LDPE) and linear low density polyethylene (LLDPE) and wherein each of said two outer layers is formed from a blend of from 5% to 20% Fluoro-elastomer in LDPE, with LLDPE and a mixed exothermic/endothermic blowing agent.

In accordance with some embodiments, a ratio between said LDPE to said LLDPE in said substrate is about 30:70, and/or wherein a ratio of said from 5% to 20% Fluoro-elastomer in LDPE to said LLDPE in said each of two outer layers is about 30:70, and/or wherein a ratio of said from 5% to 20% Fluoro-elastomer in LDPE to said mixed exothermic/endothermic blowing agent in said each of two outer layers is from about 95.5 to about 97.3.

In accordance with some embodiments, a ratio between said LDPE to said LLDPE in said substrate is 30:70.

In accordance with some embodiments, a ratio of said from 5% to 20% fluoro elastomer in LDPE to said LLDPE in said each of two outer layers is 30:70.

In accordance with some embodiments, a ratio of said from 5% to 20% fluoro elastomer in LDPE to said mixed exothermic/endothermic blowing agent in said each of two outer layers is from 95.5 to 97.3.

In accordance with some embodiments, a ratio of thickness between said substrate and each of said outer layers is about 100:30:30.

In accordance with some embodiments, the at least one outer layer comprises between about 0.5% (w/w) and about 10% (w/w) of the composite structure.

In accordance with some embodiments, each of said two outer layers is prepared from a blend comprising a mixture selected from the group consisting of:

a) from about 1% to about 40% of said 10% Fluoro-elastomer in LDPE; and from about 1% to about 56% (w/w) of said mixed exothermic/endothermic blowing agent;
b) from about 1% to about 40% of said Fluoro-elastomer in LDPE; and from about 2% to about 5% of an exothermic blowing agent;
c) from about 1% to about 40% of said Fluoro-elastomer in LDPE; and about 1% to about 5% of an endothermic blowing agent; and
d) from about 1% to about 40% of said Fluoro-elastomer in LDPE; and about 0.2% to about 5% of an endothermic blowing agent, and from about 0.5% to about 10% of a Nucleator.

In accordance with some embodiments, each of said two outer layers is prepared from a blend comprising a mixture of from 1% to 40% of said 10% fluoro elastomer in LDPE; and from 1% to 56% (w/w) of said mixed exothermic/endothermic blowing agent.

In accordance with some embodiments, each of said two outer layers is prepared from a blend comprising a mixture of from 1% to 40% of said fluoro elastomer in LDPE; and from 2% to 5% of an exothermic blowing agent.

In accordance with some embodiments, each of said two outer layers is prepared from a blend comprising a mixture of from 1% to 40% of said fluoro elastomer in LDPE; and 1% to 5% of an endothermic blowing agent.

In accordance with some embodiments, each of said two outer layers is prepared from a blend comprising a mixture of from 1% to 40% of said fluoro elastomer in LDPE; and 0.2% to 5% of an endothermic blowing agent, and from 0.5% to 10% of a Nucleator.

In accordance with some embodiments, there is provided a method of preparing a composite structure having at least one external surface having increased hydrophobicity, said method comprising the steps of:

i. preparing a blend as disclosed herein; and

ii. applying said blend as a layer on at least one external surface of a substrate under conditions that initiate gas generation from said blowing agent,

thereby forming an open cell structure on the at least one external surface, having said increased hydrophobicity.

In accordance with some embodiments, there is provided a method of preparing a composite structure having at least one external surface having increased hydrophobicity, said method comprising the steps of:

i. preparing a blend as disclosed herein; and

ii. coextruding said blend as a film together with a composition for forming a polymeric substrate, under conditions that initiate gas generation from said blowing agent,

thereby forming an open cell structure on the at least one external surface, having said increased hydrophobicity.

In accordance with some embodiments, the method further comprises removing a portion of the upper surface of the polymer film, for example by performing a cohesive failure peeling (i.e., cohesion peel-seal film ripping process) to said layer on said at least one outer surface to increase the hydrophobicity of the polymer film surface, for example, by exposing an open cell morphology on said surface.

In accordance with some embodiments, there is provided a composite structure comprising a substrate and at least one outer layer comprising a polymeric film having a surface with increased hydrophobicity, the film comprising between 1 and 30% of a composition comprising at least one polyolefin, at least one fluoropolymer and at least one blowing agent residue; and between 70 and 99% by weight of a bulk foamable polyolefin, wherein said substrate comprises a combination of LDPE and LLDPE and said at least one outer layer is formed from a blend comprising at least one polyethylene and acrylic modified perfluoro polymer or fluoro-elastomer and an azodicarbonamide blowing agent.

In accordance with some embodiments, there is provided a composite structure comprising a substrate and two outer layers, each outer layer comprising a polymeric film having a surface with increased hydrophobicity, the film comprising between 1 and 30% of a composition comprising at least one polyolefin, at least one fluoropolymer and at least one blowing agent residue; and between 70 and 99% by weight of a bulk foamable polyolefin wherein said substrate comprises low density polyethylene (LDPE) and linear low density polyethylene (LLDPE) and wherein each of said two outer layers is formed from a blend of from 5% to 20% Fluoro-elastomer in LDPE, with LLDPE and a mixed exothermic/endothermic blowing agent.

In accordance with some embodiments, there is provided a composite structure comprising a substrate and two outer layers, each outer layer comprising a polymeric film having a surface with increased hydrophobicity, the film comprising between 1 and 30% of a composition comprising at least one polyolefin, at least one fluoropolymer and at least one blowing agent residue; and between 70 and 99% by weight of a bulk foamable polyolefin wherein said substrate comprises low density polyethylene (LDPE) and linear low density polyethylene (LLDPE), wherein each of said two outer layers is formed from a blend of from 5% to 20% Fluoro-elastomer in LDPE, with LLDPE and a mixed exothermic/endothermic blowing agent and wherein a ratio between said LDPE to said LLDPE in said substrate is about 30:70.

In accordance with some embodiments, there is provided a composite structure comprising a substrate and two outer layers, each outer layer comprising a polymeric film having a surface with increased hydrophobicity, the film comprising between 1 and 30% of a composition comprising at least one polyolefin, at least one fluoropolymer and at least one blowing agent residue; and between 70 and 99% by weight of a bulk foamable polyolefin wherein said substrate comprises low density polyethylene (LDPE) and linear low density polyethylene (LLDPE), wherein each of said two outer layers is formed from a blend of from 5% to 20% Fluoro-elastomer in LDPE, with LLDPE and a mixed exothermic/endothermic blowing agent and wherein a ratio of said from 5% to 20% Fluoro-elastomer in LDPE to said mixed exothermic/endothermic blowing agent in said each of two outer layers is from about 95.5 to about 97.3.

In accordance with some embodiments, there is provided a composite structure comprising a substrate and two outer layers, each outer layer comprising a polymeric film having a surface with increased hydrophobicity, the film comprising between 1 and 30% of a composition comprising at least one polyolefin, at least one fluoropolymer and at least one blowing agent residue; and between 70 and 99% by weight of a bulk foamable polyolefin wherein said substrate comprises low density polyethylene (LDPE) and linear low density polyethylene (LLDPE), wherein each of said two outer layers is formed from a blend of from 5% to 20% Fluoro-elastomer in LDPE, with LLDPE and a mixed exothermic/endothermic blowing agent and wherein a ratio between said LDPE to said LLDPE in said substrate is about 30:70 and wherein a ratio of thickness between said substrate and each of said outer layers is about 100:30:30.

In accordance with some embodiments, there is provided a composite structure comprising a substrate and two outer layers, each outer layer comprising a polymeric film having a surface with increased hydrophobicity, the film comprising between 1 and 30% of a composition comprising at least one polyolefin, at least one fluoropolymer and at least one blowing agent residue; and between 70 and 99% by weight of a bulk foamable polyolefin wherein said substrate comprises low density polyethylene (LDPE) and linear low density polyethylene (LLDPE), wherein each of said two outer layers is formed from a blend of from 5% to 20% Fluoro-elastomer in LDPE, with LLDPE and a mixed exothermic/endothermic blowing agent and wherein a ratio between said LDPE to said LLDPE in said substrate is about 30:70 and wherein a ratio of thickness between said substrate and each of said outer layers is about 100:30:30 and wherein said at least one outer layer comprises between about 0.5% (w/w) and about 10% (w/w) of the composite structure.

In accordance with some embodiments, there is provided a composite structure comprising a substrate and two outer layers, each outer layer comprising a polymeric film having a surface with increased hydrophobicity, the film comprising between 1 and 30% of a composition comprising at least one polyolefin, at least one fluoropolymer and at least one blowing agent residue; and between 70 and 99% by weight of a bulk foamable polyolefin, wherein each of said two outer layers is prepared from a blend comprising a mixture comprising from about 1% to about 40% of said 10% Fluoro-elastomer in LDPE; and from about 1% to about 56% (w/w) of said mixed exothermic/endothermic blowing agent.

In accordance with some embodiments, there is provided a composite structure comprising a substrate and two outer layers, each outer layer comprising a polymeric film having a surface with increased hydrophobicity, the film comprising between 1 and 30% of a composition comprising at least one polyolefin, at least one fluoropolymer and at least one blowing agent residue; and between 70 and 99% by weight of a bulk foamable polyolefin, wherein each of said two outer layers is prepared from a blend comprising a mixture comprising from about 1% to about 40% of said Fluoro-elastomer in LDPE; and from about 2% to about 5% of an exothermic blowing agent.

In accordance with some embodiments, there is provided a composite structure comprising a substrate and two outer layers, each outer layer comprising a polymeric film having a surface with increased hydrophobicity, the film comprising between 1 and 30% of a composition comprising at least one polyolefin, at least one fluoropolymer and at least one blowing agent residue; and between 70 and 99% by weight of a bulk foamable polyolefin, wherein each of said two outer layers is prepared from a blend comprising a mixture comprising from about 1% to about 40% of said Fluoro-elastomer in LDPE; and about 1% to about 5% of an endothermic blowing agent.

In accordance with some embodiments, there is provided a composite structure comprising a substrate and two outer layers, each outer layer comprising a polymeric film having a surface with increased hydrophobicity, the film comprising between 1 and 30% of a composition comprising at least one polyolefin, at least one fluoropolymer and at least one blowing agent residue; and between 70 and 99% by weight of a bulk foamable polyolefin, wherein each of said two outer layers is prepared from a blend comprising a mixture comprising from about 1% to about 40% of said Fluoro-elastomer in LDPE; and about 0.2% to about 5% of an endothermic blowing agent, and from about 0.5% to about 10% of a Nucleator.

In accordance with some embodiments, there is provided a method of preparing a composite structure having at least one external surface having increased hydrophobicity, said method comprising the steps of:

i. preparing a blend suitable for use in preparing a polyolefin-based product having a surface with increased hydrophobicity, the blend comprising between 1 and 30% of the composition of a composition comprising at least one foamable polyolefin, at least one fluoropolymer and at least one blowing agent which is non-gaseous prior to activation by the application of heat, and between 70 and 99% by weight of a bulk foamable polyolefin; and

ii. applying said blend as a layer on at least one external surface of a substrate under conditions that initiate gas generation from said blowing agent,

thereby forming an open cell structure on the at least one external surface, having said increased hydrophobicity.

In accordance with some embodiments, there is provided a method of preparing a composite structure having at least one external surface having increased hydrophobicity, said method comprising the steps of:

i. preparing a blend suitable for use in preparing a polyolefin-based product having a surface with increased hydrophobicity, the blend comprising between 1 and 30% of a composition comprising at least one foamable polyolefin, at least one fluoropolymer and at least one blowing agent which is non-gaseous prior to activation by the application of heat, and between 70 and 99% by weight of a bulk foamable polyolefin; and

ii. applying said blend as a layer on at least one external surface of a substrate under conditions that initiate gas generation from said blowing agent.

thereby forming an open cell structure on the at least one external surface, having said increased hydrophobicity further comprising removing an upper surface of the polymer film, for example by performing a cohesive failure peeling (i.e., cohesion peel-seal film ripping process) to said layer on said at least one outer surface to increase the hydrophobicity thereof, for example by exposing an open cell morphology on said surface.

The Applicants have realized that some conventional products may include, at most, fluoropolymer which is present but only in the form of powder, particle or fiber. The Applicants have realized that conventional products exclude, or do not comprise, at least one polyolefin and at least one fluoropolymer which constitute a homogeneous polymeric blend.

In accordance with some embodiments, the fluoropolymer is a non-powder non-particle non-fiber ingredient of the product(s) of the present invention.

In accordance with some embodiments, the fluoropolymer is a non-powder ingredient of the product(s) of the present invention.

In accordance with some embodiments, the fluoropolymer is a non-particle ingredient of the product(s) of the present invention.

In accordance with some embodiments, the fluoropolymer is a non-fiber ingredient of the product(s) of the present invention.

In accordance with some embodiments, at least one polyolefin and at least one fluoropolymer constitute a homogeneous polymeric blend.

In accordance with some embodiments, at least one polyolefin and at least one fluoropolymer constitute a homogeneous polymeric blend, which is non-powder and non-particle and non-fiber.

In accordance with some embodiments, at least one polyolefin and at least one fluoropolymer constitute a homogeneous polymeric blend, which is non-powder.

In accordance with some embodiments, at least one polyolefin and at least one fluoropolymer constitute a homogeneous polymeric blend, which is non-particle or is in non-particulate form.

In accordance with some embodiments, at least one polyolefin and at least one fluoropolymer constitute a homogeneous polymeric blend, which is non-fiber.

In accordance with some embodiments, the fluoropolymer is a non-powder ingredient and/or a non-particle ingredient and/or a non-fiber ingredient and/or a non-particled ingredient and/or a non-particulate ingredient and/or a non-powdered ingredient and/or a non-fibered ingredient and/or a non-fibrous ingredient and/or a non-crushed ingredient and/or a non-ground ingredient and/or a non-particulate ingredient and/or a non-particled ingredient, of the product(s) of the present invention.

The terms “non-particle” or “non-particled” or “non-particulate” as used herein include, for example, a material or ingredient that is in a form other than particulate form, or a material that is not in the form of discrete particles or granular particles or minute separate particles or minuscule separate particles.

The terms “non-powder” or “non-powdered” as used herein include, for example, a material or ingredient that is in a form other than powder form, or a material that is not in the form of discrete powder particles or powdered particles or powdered-like particles; or is not in a powder-like form that is obtained by grinding or crushing or disintegration of a solid substance.

The terms “non-fiber” or “non-fibered” or “non-fibrous” as used herein include, for example, a material or ingredient that is in a form other than fiber form, or a material that is not in the form of fiber or fibers of fibrous form, or not in the form of string-like or hair-like, or not in the form of filament(s) or thread(s), or a non-tread or non-threaded form, or a non-filament form.

In accordance with some embodiments, the fluoropolymer excludes powder and excludes particle-form ingredient(s) and excludes fiber(s) and excludes filaments and excludes threads.

The Applicants have realized that conventional products, at most, use PTFE as the fluoropolymer, which is not a fluoro elastomer. In contrast, some embodiments of the present invention include products in which the fluoro elastomer is the fluoropolymer, or in which the fluoropolymer is the fluoro elastomer.

### EXAMPLES

The teachings herein were experimentally confirmed by preparation of a number of embodiments of a composite structure according to the teachings herein by, specifically, three-layer sheets (ABA-type, in cross section as depicted in FIG. 2A) that include a 100 micrometer thick polyethylene substrate sandwiched between two identical 30 micrometer thick polymer films. In some instances, the outer layers were made from a polymer composition for comparative purposes. In some instances, the outer layers were made from a polymer blend according to the teachings herein so that resulting outer layers were polymer films according to the teachings herein.

All materials for making the composite structures were available and acquired from commercial sources.

All such sheets were prepared by cast film coextrusion of three layers using a film extruder (a cast film co-extrusion system from Randcastle Extrusion Systems, Inc.) with a 3-layer die head extruding the three layers onto a chilling roll. As used herein, the term “bottom layer” will refer to the polymer film which contacts the chilling roll on exiting the die head and the term “top layer” will be the other polymer film.

Masterbatch components were acquired or prepared using a bench-mounted 16 mm PRISM Eurolab CL twin-screw extruder (Thermo Fisher Scientific, Waltham, Mass., USA), to produce sheets of fluoropolymers, nucleators and blowing agents homogeneously dispersed in a polyolefin. The produced sheets were comminuted to produce particles (flakes) suitable for feeding into the hopper of the cast film coextruder.

The composite structures were made by feeding the appropriate particles (flakes and/or pellets) into the appropriate hopper of the cast film coextruder. For polymer films according to the teachings herein, the desired combination of two or three different types of particles making up the masterbatch (fluoropolymer dispersed in polyolefin, blowing agent dispersed in polyolefin and, when required, nucleator dispersed in polyolefin) were mixed and placed inside the appropriate hopper of the cast film extruder together with the desired bulk foamable polyolefin to constitute the required polymer blend to make the desired polymer film according to the teachings herein.

The three-layer sheets were formed upon extrusion from the die of the cast film coextruder onto the chilling roll and underwent monoaxial stretching in the usual way.

Static contact angles of the polymer films were determined in the usual way using the optical contact angle measuring and contour analysis systems of the OCA series available from DataPhysics Instruments GmbH, Germany. Unless otherwise noted, the values that are reported below are an average of ten contact angle values determined from five different locations on the top surface and five different location on the bottom surface a given sheet where higher contact angle values indicate a greater hydrophobicity.

The slip angle of the polymer film was determined by placing a polymer film on a flat controllably-tiltable table. When the table was perpendicular to the gravity vector, a drop of water was placed at some location on the polymer film. One end of the table was gradually lifted, thereby increasing the tilt of the table relative to the gravity vector. The slip angle of the location was recorded as the angle at which the drop started to roll. The values that are reported below are an average of ten slip angle values determined from five different locations on the top surface and five different locations on a bottom surface a given sheet where lower slip angle values indicate a greater hydrophobicity.

Scanning electron microscopy (SEM) images of the surfaces of some polymer films was acquired using a scanning electron microscope (Aspex Explorer SEM, USA).

### First Set of Experiments

Sheets 1-10, ref 1 and ref 2 were made in a first set of experiments. The composition of these sheets appears in Table I, below. Sheets 1-4, ref 1 and ref 2 were made for comparative purposes. Sheets 5-10 were composite structures according to the teachings herein.

### Substrate (B Layer)

The 100 micrometer thick substrate (B) layer of all the sheets was made from a composition that was a combination of 70% by weight LLDPE pellets (Dowlex® NG5056 from Dow Chemical Co., Midland, Mich., USA) with 30% by weight LDPE pellets (LD158® from ExxonMobil, Irving, Tex., USA).

### Blowing Agent Particles

Some of the A layers of the sheets were made of particles including a combined exothermic/endothermic blowing agent designated MB 1 from Kafrit Industries (Kfar Aza, Israel) dispersed in polyolefin. MB 1 was a masterbatch component, being particles suitable for extrusion having a composition of 45:15:2:38 (w/w) azodicarbonamide (ADC)/sodium bicarbonate/citric acid/LDPE.

### Nucleator Particles

Some of the A layers of the sheets included as a nucleator, Hyperform® HPN 20E by Milliken Chemical Company (Spartanburg, S.C., USA), a mixture of zinc stearate (34.0%) and 1,2-cyclohexanedicarboxylic acid, calcium salt (66.0%). For extrusion, particles of a masterbatch component were prepared including 2% (w/w) Hyperform® HPN 20E homogeneously dispersed in 98% LLDPE (Dowlex® 2607G).

### Fluoropolymer Particles and Composition of the a Layers

The A layers of comparative sheets 1-4 and ref 1 was made of LLDPE (Dowlex® NG5056G from Dow Chemical Co.) and were devoid of fluoropolymer. The processing parameters of these five sheets were as follows:

| | | Temperature profile [° C.] | | | | | | |
|---|---|---|---|---|---|---|---|---|
| Extruder | RPM | Extruder | | | | Feed-Block | Die | Chill-roll |
| A | — | — | — | — | — | 210 | 210 | 20 |
| B (Outer layer) | 60 | 180 | 190 | 200 | 210 | | | |
| C (Center layer) | 100 | 180 | 190 | 200 | 210 | | | |

The A layers of comparative sheet ref 2 included fluoropolymer and was made of PE/MB fluoro-2 particles, being fluoropolymer dispersed in polyolefin devoid of blowing agent, see below.

The A layers of sheets 5-10 were polymer films according to the teachings herein and were made of a combination of PE/MB fluoro-2 particles, particles with dispersed blowing agent (MB 1, above) and, in some instances, nucleator (HPN 20E, above).

PE/MB fluoro-2 particles had a composition of 3% fluoropolymer (w/w) dispersed in 27% LDPE+70% LLDPE). The particles of PE/MB fluoro-2 were made by combining 30% of particles of a composition called MB fluoro-2 (10% acrylic-modified PTFE (Metablen® A-3800 from Mitsubishi Chemical Corporation, Tokyo, Japan) dispersed in 90% LDPE (LDPE LD158 from ExxonMobil)) with 70% LLDPE (Dowlex® NG5056G from Dow Chemical Co.) as a bulk foamable polyolefin.

The processing parameters of fluoropolymer-containing sheets ref 2 and 5-10 were as follows:

| | | Temperature profile [° C.] | | | | | | |
|---|---|---|---|---|---|---|---|---|
| Extruder | RPM | Extruder | | | | Feed-Block | Die | Chill-roll |
| A | — | — | — | — | — | 215 | 215 | 20 |
| B (Outer layer) | 60 | 180 | 190 | 200 | 210 | | | |
| C (Center layer) | 100 | 180 | 190 | 200 | 210 | | | |

TABLE I
Composition of the two 30-micrometer thick A layers
of sheets in the first set of experiments

| | | | | MB 1 | HPN20E |
|---|---|---|---|---|---|
| | polyolefin | polyolefin | fluoropolymer | blowing | nucleator |
| | added | content | content | agent | content |
| sheet | [%] | [%] | [%] | content [%] | [%] |
| 1 | NG5056G | 98.14 | 0 | 1.86 | — |
| | (97) | (LLDPE + | | | |
| | | LDPE) | | | |
| 2 | NG5056G | 96.9 | 0 | 3.1 | — |
| | (95) | (LLDPE + | | | |
| | | LDPE) | | | |
| 3 | NG5056G | 98.14 | 0 | 1.86 | 0.06 |
| | (94) | (LLDPE + | | | |
| | | LDPE) | | | |
| 4 | NG5056G | 96.84 | 0 | 3.1 | 0.06 |
| | (92) | (LLDPE + | | | |
| | | LDPE) | | | |
| ref-1 | NG5056G | 100 | 0 | 0 | — |
| | (100) | (LLDPE) | | | |
| 5 | PE/MB | 95.23 | 2.91 | 1.86 | — |
| | fluoro-2 | (LDPE + | | | |
| | (97) | LLDPE) | | | |
| 6 | PE/MB | 94.05 | 2.85 | 3.1 | — |
| | fluoro-2 | (LDPE + | | | |
| | (95) | LLDPE) | | | |
| 7 | PE/MB | 91.1 | 2.7 | 6.2 | — |
| | fluoro-2 | (LDPE + | | | |
| | (90) | LLDPE) | | | |
| 8 | PE/MB | 95.26 | 2.82 | 1.86 | 0.06 |
| | fluoro-2 | (LDPE + | | | |
| | (94) | LLDPE) | | | |
| 9 | PE/MB | 94.1 | 2.7 | 3.1 | 0.1 |
| | fluoro-2 | (LDPE + | | | |
| | (90) | LLDPE) | | | |
| 10 | PE/MB | 91.15 | 2.55 | 6.2 | 0.1 |
| | fluoro-2 | (LDPE + | | | |
| | (85) | LLDPE) | | | |
| ref-2 | PE/MB | 97 | 3 | — | — |
| | fluoro-2 | (LDPE + | | | |
| | (100) | LLDPE) | | | |

### Summary of Results of the First Set of Experiments

A first ABA sheet having a polymer film according to the teachings was made, (not listed above), where the composition of the A layers included 1.86% blowing agent (MB 1) as a fluoropolymer 2.91% PTFE (PTFE 6N X from The Chemours Company, Wilmington, Del., USA) in 95.23% LLDPE (NG5056G). The resulting sheet was unsatisfactory, apparently due to large differences in the processing temperatures of the PTFE with the LLDPE. It was therefore decided that further sheets would include acrylic-modified fluoropolymers.

Comparative sheet 3, where the A layer was made of a polymer blend without a fluoropolymer having a blowing agent content of 6.2%, there was an unstable melt flow and large holes appeared in the extruded film.

Sheet 7, a composite structure according to the teachings herein where the A layer was made of a polymer blend with fluoropolymer, devoid of nucleator and having a 6.2% blowing agent content, there was a stable melt flow and an acceptable extruded polymer film A layer.

Sheet 10, a composite structure according to the teachings herein where the A layer was made of a polymer blend with fluoropolymer, a nucleator and having 6.2% blowing agent content, there was an unstable melt flow and large holes appeared in the extruded polymer film A layer.

### SEM Images

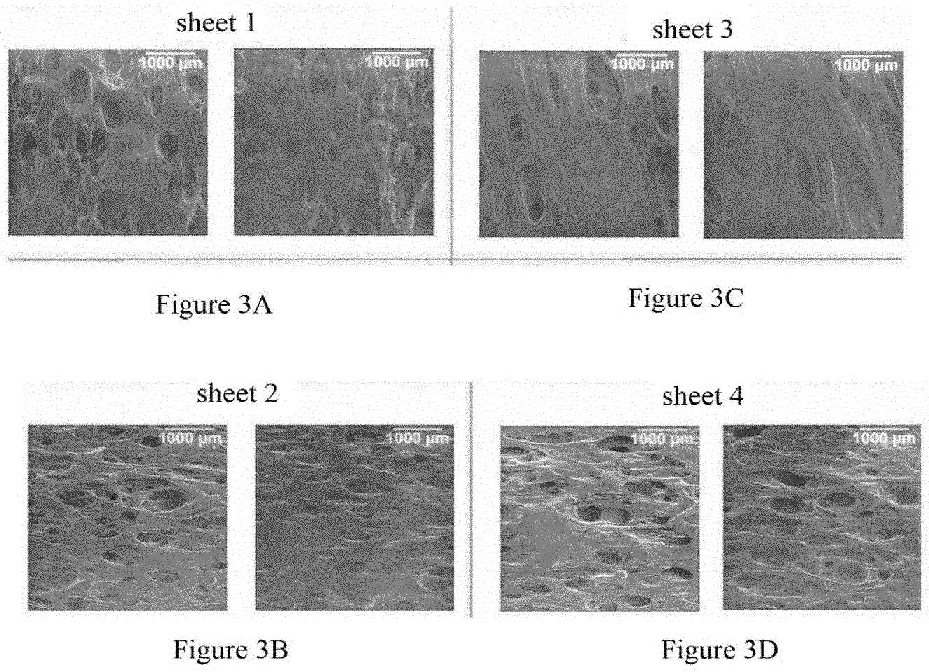

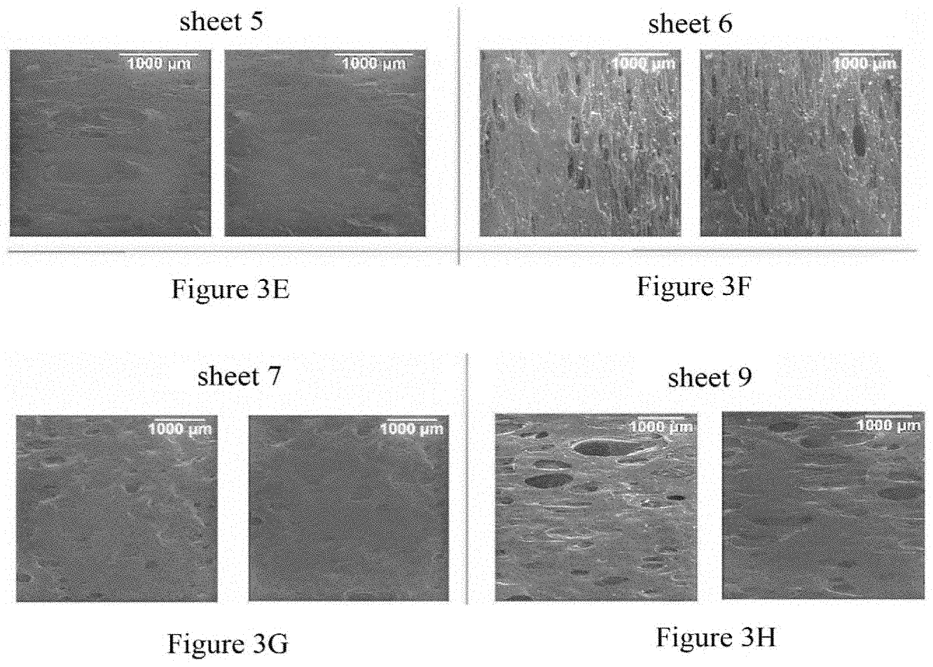

SEM images of the surfaces of the polymers film A layers made from a polymer blend including a blowing agent are reproduced in FIG. 3: sheet 1 in FIG. 3A, sheet 2 in FIG. 3B, sheet 3 in FIG. 3C, sheet 4 in FIG. 3D, sheet 5 in FIG. 3E, sheet 6 in FIG. 3F, sheet 7 in FIG. 3G, and sheet 9 in FIG. 3H.

From the SEM images it is seen that the surfaces have a mixed morphology of open and closed cells, indicating that the blowing agent was activated and that the polymer film A layers were foams.

Comparing comparative sheets 1 and 2 in FIGS. 3A and 3B (no nucleator) to comparative sheets 3 and 4 in FIGS. 3C and 3D (with nucleator), it is seen that the addition of a nucleator increases the size of the cells and the cells seem to have an elongated elliptical shape, presumably a result of stretching and a decrease in the melt viscosity. It was noted during the processing, that the melts of sheets 3 and 4 were significantly less viscous than the melts of sheets 1 and 2.

For sheets 5-7 and 9 according to the teachings herein, SEM images revealed the presence of fluoropolymer on the surface. As with sheets 1-4, a mixed morphology of open and closed cells was observed. Compared to sheets 1-4, sheets 5-7 and had relatively small cells.

### Average Static Contact Angles

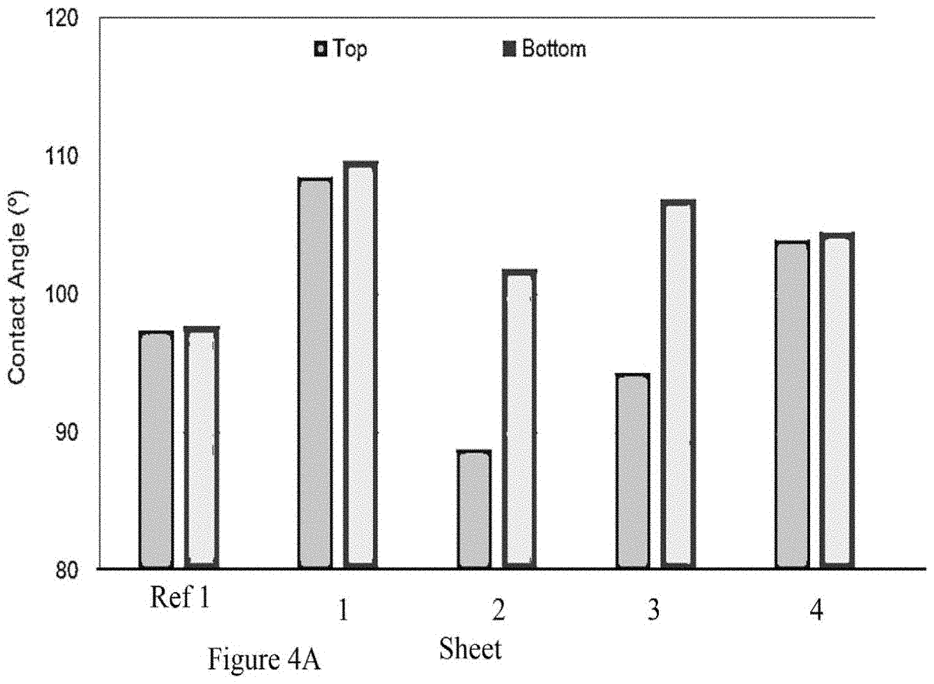

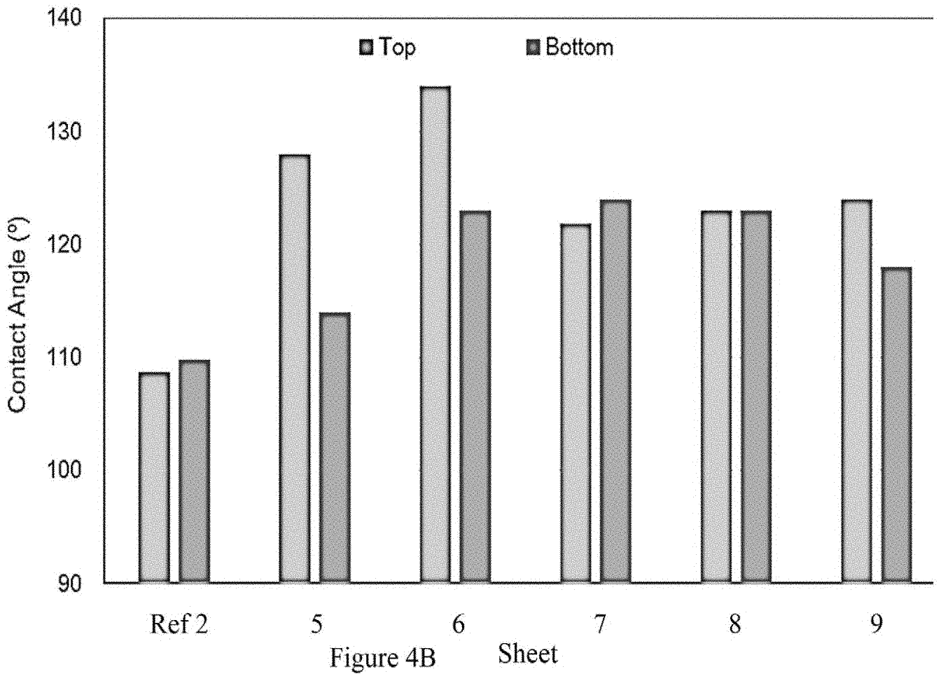

The average static contact angles determined for films 1-10 are depicted in bar graphs for sheets ref 1 and 1-4 in FIG. 4A and for sheets ref 2 and 5-9 in FIG. 4B.

Comparing comparative sheet 1 (1.86% blowing agent) to sheet ref 1 (0% blowing agent), both devoid of fluoropolymer and nucleator, the addition of 1.86% blowing agent led to an average contact angle increase of about 10°, attributed to the rough surface texture caused by the gas generated by the blowing agent. Comparing sheet 1 (1.86% blowing agent) to sheets 2 and 4 (3.1% blowing agent), the increased blowing agent content led to reduction in average contact angle. In sheets 1-4, the bottom surface which was in contact with the chilling roller was found to have a higher contact angle than the top surface.

Comparing sheets 5-9 and ref 2 (all with fluoropolymer) to comparative sheets 1-4 and ref 1 (all devoid of fluoropolymer), it is seen that the presence of fluoropolymer in the film increases the static contact angle.

The highest improvement relative to ref 1 (no fluoropolymer, 1.86% blowing agent) was sheet 6 (fluoropolymer, 3.1% blowing agent, no nucleator) where the top surface contact angle increased by 36° (134° vs 98°).

Higher blowing agent content, with or without nucleator, did not necessarily increase the contact angle with a maximum of 135° attained by the top layer of sheet 6 (fluoropolymer, 3.1% blowing agent).

### Second Set of Experiments

Sheets 11-16, ref 3, ref 4, HD/MD ref and PP(HP) ref were made in a second set of experiments to study the effect of a different foamable polyolefin, a different blowing agent and different nucleators. The composition of these sheets appears in Table II, below. Sheets ref 3 and ref 4 were made for comparative purposes. Sheets 11-16 were composite structures according to the teachings herein.

### Substrate (B Layer)

As with the first set of experiments, the 100 micrometer thick substrate layer of all the sheets was made from a composition that was a combination of 70% by weight LLDPE pellets (Dowlex® NG5056 from Dow Chemical Co.) with 30% by weight LDPE pellets (LD158 from ExxonMobil).

### Composition of the a Layers

The A layers of sheets 11-13 and ref 3 were made of the composition called PE/MB fluoro-2 (3% fluoropolymer+27% LDPE+70% LLDPE) described above. Sheets 11-13 also included, a blowing agent and, in some instances, nucleator.

The A layers of sheets 14-16, ref 4 and PP/MB fluoro-2 were made of a composition called PP/MB fluoro-2. PP/MB fluoro-2 was made by combining MB fluoro-2 described above with 70% PP (Capilene® E50E from Carmel Olefins Ltd., Haifa, Israel)). Sheets 14-16 also included a blowing agent and, in some instances, a nucleator.

The A layers of a reference sheet HD/MD ref was a commercially available mixture of HDPE and MDPE (Marlex® 5202 by Chevron Phillips Chemical Co, The Woodlands, Tex., USA).

### Blowing Agent

Some of the A layers of the sheets were made of particles including an exothermic blowing agent designated MB FM4 from Kafrit Industries (Kfar Aza, Israel) dispersed in polyolefin. MB FM4 was a masterbatch component, being particles suitable for extrusion having a composition of 40:60 (w/w) azodicarbonamide (ADC)/LDPE.

### Nucleator

As a nucleator, the A layers of sheets 12 and 15 included talc, Crys-Talc® 7C from Imerys Performance Minerals (Toulouse, France). The talc was added as masterbatch particles consisting of 10% (w/w) talc in 90% Capilene® R-50, a polypropylene homopolymer from Carmel Olefins Ltd.

As a nucleator, the A layers of sheet 13 included 1% Cloisite® 15A Nanoclay (montmorillonite organically modified with a quaternary ammonium salt octadecyl ammonium chloride) from Byk Additives and Instruments, GMbH, Germany. The nucleator was added as particles comprising 10% (w/w) Cloisite® 15A in 90% Capilene® R-50, a polypropylene homopolymer from Carmel Olefins Ltd.

As a nucleator, the A layers of sheet 16 included 1% Cloisite® 93A Nanoclay (montmorillonite organically modified with a ternary ammonium salt) from Byk Additives and Instruments, GMbH, Germany. The nucleator was added as particles comprising 10% (w/w) Cloisite® 93A in 90% Capilene® R-50, a polypropylene homopolymer from Carmel Olefins Ltd.

### Processing Parameters

The processing parameters used for sheets 11-16, ref 3, ref 4, HD(MD) and PP(HP) ref were the same as used for sheets 5-10 described above.

### Cohesive Failure Peeling

A sample of each one of the sheets 5, 6 and 11-16 underwent cohesive failure peeling on both surfaces to remove an upper portion of the bottom layer and of the top layer. Peeling sheets having a 20 micrometer thick backing layer of BOPET (biaxially oriented polyethylene terephtalate) and a 100 micrometer thick bonding layer of Toppyl® SP 2103C (LyondellBasell, Rotterdam, The Netherlands) were prepared by coextrusion. The bonding layer of a peeling sheet was bonded to each one of two polymer film surfaces of a sample sheet using heat sealing yielding a laminate. The two peeling sheets were separated from the sample in the usual way so that the sample now had two peeled surfaces.

TABLE 11
Composition of the two 30-micrometer thick A
layers of sheets in the second set of experiments

| | | | | MB FM4 | |
|---|---|---|---|---|---|
| | poly- | poly- | fluoro- | blowing | |
| | olefin | olefin | polymer | agent | nucleator |
| | added | content | content | content | content |
| sheet | [%] | [%] | [%] | [%] | [%] |
| 11 | PE/MB | 93.3 | 2.7 | 4 | — |
| | fluoro-2 | (LDPE + | | (MB | |
| | (90%) | LLDPE) | | FM4)) | |
| 12 | PE/MB | 93.23 | 2.67 | 4 | 0.1 |
| | fluoro-2 | (LDPE + | | (MB | (talc) |
| | (89%) | LLDPE) | | FM4) | |
| 13 | PE/MB | 92.6 | 2.4 | 4 | 1 |
| | fluoro-2 | (LDPE + | | (MB | (NA-15A) |
| | (80%) | LLDPE + | | FM4) | |
| | | PP) | | | |
| 14 | PP/MB | 93.3 | 2.7 | 4 | — |
| | fluoro-2 | (PP) | | (MB | |
| | (90%) | | | FM4) | |
| 15 | PP/MB | 93.23 | 2.67 | 4 | 0.1 |
| | fluoro-2 | (PP) | | (MB | (talc) |
| | (89%) | | | FM4) | |
| 16 | PP/MB | 92.6 | 2.4 | 4 | 1 |
| | fluoro-2 | (PP) | | (MB | (NA-93A) |
| | (80%) | | | FM4) | |
| ref 3 | PE/MB | 97 | 3 | — | — |
| | fluoro-2 | (LDPE + | | | |
| | (100) | LLDPE) | | | |
| ref 4 | PP/MB | 70 | 30 | — | — |
| | fluoro-2 | (PP) | | | |
| | (100) | | | | |
| HD/ | HDPE/ | 100 | — | — | — |
| MD | MDPE | (PE) | | | |
| ref | (100) | | | | |
| PP | PP/MB | 70 | 30 | — | — |
| (HP) | fluoro-2 | (PP) | | | |
| ref | (100) | | | | |

### Summary of Results of the Second Set of Experiments

The hydrophobicity of the surfaces of the polymer films were determined by measuring the average static contact angles and the slip angles of the surfaces of the sheets listed in Table II and the results are presented in Table III. The values found in Table III are an average of 10 measurements, 5 from different locations on the top surface of a sheet and 5 from different locations on the bottom of a sheet.

The hydrophobicity of results sheets 11-16 (PE or PP with fluoropolymer, MB FM4 blowing agent, with or without nucleator) are arguably inferior than those of sheets 5 and 6 (PE with fluoropolymer and MB 1 blowing agent, devoid of nucleator), that is to say, the attained increase of hydrophobicity is lower in terms of increased contact angle and slip angle.

The purely exothermic blowing agent MB FM4 (consisting of azodicarbonamide) used in sheets 11-16 did not substantially improve the results compared to the mixed endothermic/exothermic blowing agent MB 1 used in sheets 1-10 (consisting of a combination of azodicarbonamide and sodium bicarbonate/citric acid).

The increased hydrophobicity resulting from the use of fluoropolymer seen with sheets 5-10 was also observed, to a lesser degree, with sheets 11-16.

TABLE III
Contact angle and slip angles for sheets
listed in Table II compared to sheets listed in Table I

| | contact angle | contact angle | slip angle | slip angle |
|---|---|---|---|---|
| | [°] | [°] | [°] | [°] |
| | (free | (peeled | (free | (peeled |
| sheet | surface) | surface) | surface) | surface) |
| 11 | 119 | 118 | 60 | 65 |
| 12 | 118 | 115 | 58 | 53 |
| 13 | 109 | 111 | 56 | 57 |
| 14 | 120 | 119 | 42 | 47 |
| 15 | 114 | 116 | 58 | 58 |
| 16 | 115 | 121 | 77 | 67 |
| ref 3 | 100 | 103 | 46 | 66 |
| ref 4 | 96 | 104 | 39 | 40 |
| HD/MD-ref | 99 | 96 | 34 | 31 |
| PP(HP)-ref | 97 | 96 | 32 | 30 |
| 5 | 128 | 115 | 25 | 27 |
| 6 | 135 | 123 | 16 | 18 |

### Third Set of Experiments

Sheets 17-26, ref 5 and ref 6 were made in a third set of experiments to study the effect of a different foamable polyolefins and a different nucleator. The composition of these sheets appears in Table IV, below. Sheets ref 5 and ref 6 were made for comparative purposes. Sheets 17-26 were composite structures according to the teachings herein.

### Substrate (B Layer)

As with the first and second set of experiments, the 100 micrometer thick substrate layer of all the sheets was made from a composition that was a combination of 70% by weight LLDPE pellets (Dowlex® NG5056 from Dow Chemical Co.) with 30% by weight LDPE pellets (LD158 from ExxonMobil).

### Composition of the a Layers

The A layers of sheets 17-18 were made of PP/MB fluoro-1 which was 3% acrylic-modified PTFE (Unidyne® TG-1001 (Daikin American, Inc., Orangeburg, N.Y., USA) in 97% PP homopolymer (Capilene® E50E from Carmel Olefins Ltd.).

The A layers of sheets 19-22 and ref 5 were made of PP/MTBN-3800 which was 3% acrylic-modified PTFE (Metablen® A-3800, Mitsubishi Chemical Corporation, Tokyo, Japan) in 97% PP homopolymer (Capilene® E50E from Carmel Olefins Ltd.).

The A layers of sheet ref 6 were made of HD-MD/MTBN-3800 which was 3% fluoropolymer (Metablen® A-3800) in a combination HDPE-MDPE (Marlex® 5202 by Chevron Phillips).

The A layers of sheets 23 and 24 were made of 60% PP random copolymer (Capilene® QC71E) and 40% HDPE-MDPE (Marlex® 5202 by Chevron Phillips).

The A layers of sheets 25 and 26 were made of:
60% PP/MB fluoro 1 (3% fluoropolymer (Unidyne® TG-1001) in 97% PP homopolymer (Capilene® E50E from Carmel Olefins)) together with
40% HD-MD/MB fluoro 2 (3% fluoropolymer (Metablen® A) in 27% LDPE (LDPE LD158 from ExxonMobil) and 70% of a combination HDPE-MDPE (Marlex® 5202 by Chevron Phillips).

### Blowing Agent

The A layers of sheets 17-21, 24 and 26 included 3.1% (w/w) of the blowing agent designated MB 1, described above.

The A layer of sheet ref 6 included a combined exothermic/endothermic blowing agent (Tracel® TSE 7145 ACR from Tramaco GmbH, Tornesch, Germany which comprises 36% by weight blowing agents, specifically 5% azodicarbonamide (exothermic), 1% 4,4′-oxybis (benzenesulfonyl hydrazide) (exothermic) and 30% (24% NaHCO₃/6% citric acid, endothermic).

### Nucleator

As a nucleator, the A layers of sheets 18 and 20 included 2% (w/w) Irgaclear® XT 386 (N,N′,N-1,3,5-benzene trilyl tris (2,2-dimethylpropanamide) from BASF (Ludwigshafen, Germany) in 98% Capilene R50, a PP homopolymer from Carmel Olefins Ltd.

### Processing Parameters

The processing parameters used for sheets 17-26, ref 5 and ref 6 were the same as used for sheets 5-10 described above.

### Cohesive Failure Peeling

A sample of each one of the sheets 5, 6, 12, 14, 20, 22, 24 and 26 underwent cohesive failure peeling on both surfaces to remove an upper portion of the bottom layer and of the top layer as described above.

TABLE IV
Composition of the two 30-micrometer thick A layers of sheets
in the third set of experiments (* the 3.2% balance of ref 6
were 1.25% organic and 1.95% inorganic carriers
of TSE 7145 blowing agent composition)

| | polyolefin | polyolefin | fluoropolymer | blowing | nucleator |
|---|---|---|---|---|---|
| | added | content | content | agent content | content |
| Sheet | [%] | [%] | [%] | [%] | [%] |
| 17 | PP/MB fluoro-1 (95%) | 94.05 | 2.85 | 3.1 | — |
| | | | | (MB 1) | |
| 18 | PP/MB fluoro-1 (94) | 94.06 | 2.82 | 3.1 | 0.02 |
| | | | | (MB 1) | (XT 386) |
| 19 | PP/MTBN-3800 (95) | 94.05 | 2.85 | 3.1 | — |
| | | | | (MB 1) | |
| 20 | PP/MTBN-3800 (94) | 94.06 | 2.82 | 3.1 | 0.02 |
| | | | | (MB 1) | (XT 386) |
| 21 | PP/MTBN-3800 (95) | 94.05 | 2.85 | 3.1 | — |
| | | | | (MB1) | |
| 22 | PP/MTBN-3800 (95) | 94.05 | 2.85 | 3.1 | — |
| | | | | (MB 1) | |
| ref 5 | PP/MTBN-3800 (100) | 97 | 3 | — | — |
| ref 6* | HD-MD/MTBN-3800(95) | 92.15 | 2.85 | 1.8 | — |
| | | | | (TSE 7145) | |
| 23 | Capilene ® | 100 | 0 | — | — |
| | QC71E (60) + | | | | |
| | Marlex ® 5202 (40) | | | | |
| 24 | Capilene ® | 96.9 | 0 | 3.1 | — |
| | QC71E (55) + | | | (MB 1) | |
| | Marlex ® 5202 (40) | | | | |
| | (95%) | | | | |
| 25 | PP/MB fluoro 1 (60) + | 97 | 3 | — | — |
| | HD-MD/MB fluoro | | | | |
| | 2 (40) (100%) | | | | |
| 26 | PP/MB fluoro 1 (55) + | 94.05 | 2.85 | 3.1 | — |
| | HD-MD/MB fluoro | | | (MB 1) | |
| | 2 (40) (95%) | | | | |

### Summary of Results of the Third Set of Experiments

The average static contact angles and the slip angles of the surfaces of the sheets listed in Table IV were determined and the results presented in Table V.

The hydrophobicity of the surfaces of the polymer films were determined by measuring the average static contact angles and the slip angles of the surfaces of the sheets listed in Table IV and the results are presented in Table V.

The values found in Table V are an average of 10 measurements, 5 from different locations on the top surface of a sheet and 5 from different locations on the bottom of a sheet.

TABLE V
Contact angle and slip angles for sheets listed in Table IV
compared to sheets listed in Tables I and II

| | contact angle [°] | contact angle [°] | slip angle [°] | slip angle [°] |
|---|---|---|---|---|
| sheet | (free surface) | (peeled surface) | (free surface) | (peeled surface) |
| 5 (I) | 128 | 146 | 25 | 12 |
| 6 (I) | 135 | 154 | 16 | 8 |
| 12 (II) | 118 | 137 | 53 | 26 |
| 14 (II) | 120 | 139 | 42 | 18 |
| 20 (IV) | 109 | 129 | 56 | 27 |
| 22 (IV) | 119 | 138 | 60 | 31 |
| 24 (IV) | 114 | 136 | 58 | 28 |
| 26 (IV) | 110 | 131 | 67 | 42 |

From the results listed in Table V it is seen that:
a. The sheets of the third set (20, 22, 24, 26) did not yield better hydrophobicity results than of the second (12, 14).
b. for all sheets, cohesive failure peeling increased hydrophobicity as indicated by the increased static contact angle and the decreased slip angle. In the case of sheet 6, the peeling provided super-hydrophobicity as indicated by a contact angle greater than 150°.
c. in some embodiments, removing a portion of the upper surface of a polymer film, for example by cohesive failure peeling, is useful for increasing the hydrophobicity of the surfaces of a polymer film according to the teachings herein.

As seen from the results presented in Tables III and V, from among the polymer films that were actually tested, the highest hydrophobicity was achieved when the polymer film was made from a combination of LLDPE/LDPE as the foamable polyolefin component/bulk foamable polyolefin, a fluoropolymer and a combined endothermic/exothermic blowing agent, such as the A layers of sheet 6.

Additional cohesive failure peeling embodiments:
Four-layer sheets are made by coextrusion having the layer structure A, B, C and D. Seven-layer sheets are made by coextrusion having the layer structure D, C, B, A, B, C, D.
The A (substrate) layers and B (polymer film) layers are as described above for sheets 1-26.
The C layers are bonding layers (preferably between 30 micrometers and 150 micrometers thick, e.g., 100 micrometers thick) made of a suitable polymer, for example, Toppyl® SP 2103C or of Toppyl® PB 8640M in polyethylene (any suitable polyethylene, such as pure or mixtures the polyethylenes recited above) in a ratio of between 5:95 to 25:75 (w/w), both Toppyl® available from LyondellBasell, Rotterdam, The Netherlands.
The D layers are backing layers that are preferably similar or identical in composition to the A (substrate) layers.
The extruded 4-layer or 7-layer sheets are allowed to cool.
The C and D layers are separated from the B layers by cohesive failure peeling, leaving a 2-layer AB sheet or a 3-layer BAB sheet where the surfaces of the B (polymer film) have increased hydrophobicity.

### Fourth Set of Experiments—Prophetic Examples

Sheets 28-33 are made in a fourth set of experiments. Sheets 28-33 are composite structures according to the teachings herein, being three-layer sheets A-B-B. The composition of the B-layers of all six sheets is LLDPE/LDPE, 70:30 w/w. The compositions of the A layers of sheets 28-33 are listed in Table VI.

### Blowing Agent

The outer A layer of sheets 28-33 include a solid endothermic blowing agent, for example, the commercially available product Ecocell®-L from Kafrit Industries (Kfar Aza, Israel). Ecocell®-L is provided as pellets having 20% CaCO3, 18% sodium citrate and 62% LDPE (w/w), where the former two ingredients are provided as particles of not more than 0.7 micrometers.

The layers are extruded from a 3-layer die head in the usual way, for example, substantially as described above. The A layer is the upper layer of the extruded sheet.

TABLE VI
Composition of the A layers of sheets 28-33

| | polyolefin | fluoropolymer | blowing agent |
|---|---|---|---|
| | content¹ | content² | content³ |
| Sheet | [%] | [%] | [%] |
| 28 | 95 | 3 | 2 |
| 29 | 94 | 3 | 3 |
| 30 | 91 | 3 | 6 |
| 31 | 95 | 3 | 2 |
| 32 | 94 | 3 | 3 |
| 33 | 91 | 3 | 6 |

¹LLDPE/LDPE, 70:30 w/w
²acrylic-modified PTFE
³CaCO3/sodium citrate, 20:18 w/w)

All three layers are all extruded at 40 micrometers thick. After extrusion and cooling, the extruded sheet is thicker, the two B layers are 40 micrometers thick but the A layer is thicker due to the action of the blowing agent, typically the A layer being between 60 and 200 micrometers thick.

The contact angle of the A layer surface, transmittance and haze of the the sheets is tested. The contact angle is determined using an OCA 200 goniometer—optical contact angle measuring and contour analysis systems (Data Physics Instruments GmbH, Filderstadt, Germany). Transmittance and haze are determined using haze-gard Transparency Transmission Haze Meter with illuminant D65 (ISO 13468) by Byk Instruments, Geretsried, Germany) a division of Altana Corporation, Wesel, Germany).

All A layer surfaces exhibit high contact angles, typically above 130°, even reaching above 140°.

All the sheets exhibit transmittance greater than 40%.

All the sheets exhibit haze of at least 20%.

The materials, compositions, structures, systems, and methods of the present invention have been described in detail by reference to various non-limiting embodiments. This description enables one skilled in the art to make and use the invention, and it describes several embodiments, adaptations, variations, alternatives, and uses of the invention. These and other embodiments, features, and advantages of the invention are apparent to a person skilled in the art upon perusal of the description of the invention and exemplified embodiments.

Unless defined otherwise, all technical and scientific terms used herein have the same meaning as is commonly understood by one of ordinary skill in the art to which this invention belongs. In case of conflict, the specification, including definitions, takes precedence.

Abbreviations used herein include: PTFE (polytetrafluoroethylene), PE (polyethylene), PP (polypropylene), LDPE (low density polyethylene), LLDPE (linear low density polyethylene), MDPE (medium-density polyethylene), mLLDPE (metallocene low liner density polyethylene) and HDPE (high-density polyethylene).

Unless otherwise noted, when a material is stated as comprising some % of a composition, the intent is (or, it means) weight percent.

As used herein, the terms “comprising”, “including”, “having” and grammatical variants thereof are to be taken as specifying the stated features, integers, steps or components but do not preclude the addition of one or more additional features, integers, steps, components or groups thereof. As used herein, the indefinite articles “a” and “an” mean “at least one” or “one or more” unless the context clearly dictates otherwise.

As used herein, when a numerical value is preceded by the term “about”, the term “about” is intended to indicate +/−10%. As used herein, a phrase in the form “A and/or B” means a selection from the group consisting of (A), (B) or (A and B). As used herein, a phrase in the form “at least one of A, B and C” means a selection from the group consisting of (A), (B), (C), (A and B), (A and C), (B and C) or (A and B and C).

Unless otherwise indicated, all numbers expressing conditions, concentrations, dimensions, and so forth used in the specification and claims, are to be understood as being modified in all instances by the term “about”. Accordingly, unless indicated to the contrary, the numerical parameters set forth in the following specification and attached claims are approximations that may vary depending at least upon a specific analytical technique or measurement. The range of the term “about” is not ever intended to convey anything other than the normally encountered levels of inaccuracy of measurement encountered in analytical methodologies or methods of measurement, and in no circumstances will the range of any figure include values greater than +/−10% of that figure within the ambit of the term about.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention.

Section headings are used herein to ease understanding of the specification and should not be construed as necessarily limiting.

Although the physical characteristics of the inventive hydrophobic surface are referred to by the terms texture, morphology, roughness, or topography, these terms are to be seen as descriptive lay terms which unless specified otherwise, are interchangeable and the use of only one or more terms rather than others is not intended to convey any distinction between the terms and nothing should read into any etymological distinctions between them.

Some embodiments may include a manufacturing system or a production system, configured to manufacture or produce one or more of the materials and/or articles that are described above and/or herein; including, for example, a system for manufacturing a masterbatch or a masterbatch composition, a blend, a homogenous blend, a polymer blend, a homogenous polymeric blend, a film, a thin film, a coating layer, a surface component or a surface layer, a hydrophobic surface layer or hydrophobic surface component, a composite structure, or the like; including also systems and methods for producing or manufacturing an entire article or an entire product that includes one or more of said materials. Such system may comprise, for example, an adding unit, a mixing unit, a blending unit, a material fetching unit, a material moving unit, a material storing unit, a heating unit, a cooling unit, a masterbatch production unit, a blend production unit, a film production unit, a structure and/or surface production unit, one or more production lines and/or robotic arms and/or conveyor belts and/or other manufacturing units; as well as a computer or an electronic device (e.g., having a processor to store code, and having a memory unit to store code) that is configured to control, command, regulate, activate and/or deactivate one or more of such manufacturing units or components.

Some embodiments provide polymer films having a surface with increased hydrophobicity or enhanced hydrophobicity or improved hydrophobicity or super-hydrophobicity; composite structures such as multilayer polymer sheets comprising the polymer films; methods and systems of making such polymer films; polymer blends from which to make such polymer films; masterbatches or masterbatch compositions useful for making such polymer blends; as well as methods and systems for making such polymer blends and such masterbatches or masterbatch compositions.

Some embodiments include a masterbatch composition suitable for use in preparing a polymer film having a surface with increased hydrophobicity,

the masterbatch composition comprising:

a foamable polyolefin component comprising at least one foamable polyolefin making up between 15% and 86% weight percent of the masterbatch composition;

a fluoropolymer component comprising at least one fluoropolymer making up between 10% and 15% weight percent of the masterbatch component; and

a blowing agent component comprising at least one heat-activated blowing agent which is non-gaseous prior to activation by the application of heat making up between 4% and 70% of the masterbatch composition;

wherein fluoropolymer component is homogeneously dispersed in at least some the foamable polyolefin component;

wherein the masterbatch has a form suitable for use as extruder feed.

In some embodiments, the masterbatch is in the form of a plurality of particles suitable for feeding to an extruder.

In some embodiments, said polyolefin component makes up between 15% and 86% weight percent of the masterbatch composition.

In some embodiments, said fluoropolymer component makes up between 10% and 15% weight percent of the masterbatch composition.

In some embodiments, said blowing agent component makes up between 4% and 70% weight percent of the masterbatch composition.

In some embodiments, said foamable polyolefin component, said fluoropolymer component, and said blowing agent component together comprise not less than 90% by weight of the masterbatch composition.

In some embodiments, said polyolefin component is at least 90% by weight of a foamable polyolefin selected from the group consisting of: polyethylene (PE), polypropylene (PP), and a combination thereof.

In some embodiments, at least one fluoropolymer making up said fluoropolymer component is selected from the group consisting of: a fluoro homopolymer, a fluoro copolymer, a fluoro-elastomer, an acrylic-modified fluoropolymer, and a combination of two or more of said materials.

In some embodiments, said fluoropolymer component is at least 50% by weight of acrylic-modified fluoropolymer.

In some embodiments, said blowing agent component is selected from the group consisting of: an endothermic blowing agent, and a combined endothermic/exothermic blowing agent.

In some embodiments, the masterbatch composition further comprises a nucleator component.

In some embodiments, said nucleator component makes up between 0.1% and 10% weight percent of the masterbatch composition.

In some embodiments, said foamable polyolefin component, said fluoropolymer component, said blowing agent component, and said nucleator component together comprise not less than 90% by weight of the masterbatch composition.

In some embodiments, the masterbatch composition comprises:

a polyolefin component comprising foamable polyethylene;

homogeneously dispersed in at least some of said polyolefin component, a fluoropolymer component comprising an acrylic-modified fluoropolymer; and

homogeneously dispersed in at least some of the polyolefin component, a blowing agent component comprising an azodicarbonamide blowing agent.

Some embodiments provide a polymer blend composition, comprising:
between 1% and 30% by weight of the masterbatch, and
between 70% and 99% by weight of a bulk foamable polyolefin.

Some embodiments provide a polymer film, made of the polymer blend composition described above or below; wherein the polymer film is a foam, and has a surface with increased hydrophobicity.

In some embodiments, the polymer film comprises:

polyethylene;

homogeneously dispersed in said polyethylene, a fluoropolymer component comprising an acrylic-modified fluoropolymer; and

blowing agent residue, comprising residue of an azodicarbonamide blowing agent.

In some embodiments, the polymer film is prepared from a polymer blend composition selected from the group consisting of:

(a) 0.1%-20% (w/w) fluoropolymer in LDPE; and from about 0.1% to about 6% (w/w) of a mixed exothermic/endothermic blowing agent;

(b) 0.1%-20% (w/w) fluoropolymer in LDPE; and about 0.1% (w/w) of an exothermic blowing agent;

(c) from about 1% to about 40% fluoropolymer in LDPE; and about 0.1% to about 6% of an endothermic blowing agent;

(d) 0.1%-20% fluoropolymer in LDPE; and about 0.2% to about 5% of an endothermic blowing agent, and from about 0.1% to about 6% of a nucleator.

Some embodiments provide a composite structure or a composite article or a composite item, comprising:

a substrate; and

distinct from said substrate, the polymer film;

wherein said polymer film defines at least one increased-hydrophobicity surface of the composite structure.

In some embodiments, the composite structure is multilayer polymer sheet having at least two layers; wherein at least one of the two outer layers of the polymer sheet being said polymer film.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Furthermore, repeated use of the phrase “in one embodiment” does not necessarily refer to the same embodiment, although it may. Similarly, repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may thus comprise any possible or suitable combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some demonstrative embodiments of the present invention have been illustrated and described herein, various modifications, substitutions, changes, and equivalents may occur to those skilled in the art. Accordingly, the claims are intended to cover all such modifications, substitutions, changes, and equivalents.

What is claimed is:

1. A masterbatch composition suitable for use in preparing a polymer film having a surface with increased hydrophobicity,
the masterbatch composition comprising:
a foamable polyolefin component comprising at least one foamable polyolefin making up between 15% and 86% weight percent of the masterbatch composition;
a fluoropolymer component comprising at least one fluoropolymer making up between 10% and 15% weight percent of the masterbatch component; and
a blowing agent component comprising at least one heat-activated blowing agent which is non-gaseous prior to activation by the application of heat making up between 4% and 70% of the masterbatch composition;
wherein fluoropolymer component is homogeneously dispersed in at least some the foamable polyolefin component;
wherein the masterbatch has a form suitable for use as extruder feed.

2. The masterbatch composition of claim 1,
wherein the masterbatch is in the form of a plurality of particles suitable for feeding to an extruder.

3. The masterbatch composition of claim 1,
where said polyolefin component makes up between 15% and 86% weight percent of the masterbatch composition.

4. The masterbatch composition of claim 1,
wherein said fluoropolymer component makes up between 10% and 15% weight percent of the masterbatch composition.

5. The masterbatch composition of claim 1,
wherein said blowing agent component makes up between 4% and 70% weight percent of the masterbatch composition.

6. The masterbatch composition of claim 1,
wherein said foamable polyolefin component, said fluoropolymer component, and said blowing agent component together comprise not less than 90% by weight of the masterbatch composition.

7. The masterbatch composition of claim 1,
wherein said polyolefin component is at least 90% by weight of a foamable polyolefin selected from the group consisting of: polyethylene (PE), polypropylene (PP), and a combination thereof.

8. The masterbatch composition of claim 1,
wherein at least one fluoropolymer making up said fluoropolymer component is selected from the group consisting of: a fluoro homopolymer, a fluoro copolymer, a fluoro-elastomer, an acrylic-modified fluoropolymer, and a combination of two or more of said materials.

9. The masterbatch composition of claim 8,
wherein said fluoropolymer component is at least 50% by weight of acrylic-modified fluoropolymer.

10. The masterbatch composition of claim 1,
wherein said blowing agent component is selected from the group consisting of:
an endothermic blowing agent, and a combined endothermic/exothermic blowing agent.

11. The masterbatch composition of claim 1,
further comprising a nucleator component.

12. The masterbatch composition of claim 11,
wherein said nucleator component makes up between 0.1% and 10% weight percent of the masterbatch composition.

13. The masterbatch composition of 11,
wherein said foamable polyolefin component, said fluoropolymer component, said blowing agent component, and said nucleator component together comprise not less than 90% by weight of the masterbatch composition.

14. The masterbatch composition of claim 1, comprising:
a polyolefin component comprising foamable polyethylene;
homogeneously dispersed in at least some of said polyolefin component, a fluoropolymer component comprising an acrylic-modified fluoropolymer; and
homogeneously dispersed in at least some of the polyolefin component, a blowing agent component comprising an azodicarbonamide blowing agent.

15. A polymer blend composition, comprising:
between 1% and 30% by weight of the masterbatch of claim 1, and
between 70% and 99% by weight of a bulk foamable polyolefin.

16. A polymer film, made of the polymer blend composition of claim 15,
wherein the polymer film is a foam, and has a surface with increased hydrophobicity.

17. The polymer film of claim 16, comprising:
polyethylene;
homogeneously dispersed in said polyethylene, a fluoropolymer component comprising an acrylic-modified fluoropolymer; and
blowing agent residue, comprising residue of an azodicarbonamide blowing agent.

18. The polymer film of claim 17,
prepared from a polymer blend composition selected from the group consisting of:
(a) 0.1%-20% (w/w) fluoropolymer in LDPE; and from about 0.1% to about 6% (w/w) of a mixed exothermic/endothermic blowing agent;
(b) 0.1%-20% (w/w) fluoropolymer in LDPE; and about 0.1% (w/w) of an exothermic blowing agent;
(c) from about 1% to about 40% fluoropolymer in LDPE; and about 0.1% to about 6% of an endothermic blowing agent;
(d) 0.1%-20% fluoropolymer in LDPE; and about 0.2% to about 5% of an endothermic blowing agent, and from about 0.1% to about 6% of a nucleator.

19. A composite structure, comprising:
a substrate; and
distinct from said substrate, the polymer film of claim 16;
wherein said polymer film defines at least one increased-hydrophobicity surface of the composite structure.

20. The composite structure of claim 19,
wherein the composite structure is multilayer polymer sheet having at least two layers,
wherein at least one of the two outer layers of the polymer sheet being said polymer film.
